(19) United States
(12) Patent Application Publication
(10) Pub. No.: US 2019/0147554 A1
(43) Pub. Date: May 16, 2019

(54) METHODS AND SYSTEMS FOR DIGITAL ASSET MANAGEMENT

(71) Applicants: Sreekanth CHINTALA, Austin, TX (US); Apoorva CHINTALA, Austin, TX (US)

(72) Inventors: Sreekanth CHINTALA, Austin, TX (US); Apoorva CHINTALA, Austin, TX (US)

(21) Appl. No.: 16/186,445

(22) Filed: Nov. 9, 2018

Related U.S. Application Data
(60) Provisional application No. 62/584,246, filed on Nov. 10, 2017.

(51) Int. Cl. G06Q 50/18; G06F 21/62

(52) U.S. Cl. CPC G06Q 50/18; G06F 21/6245

(57) ABSTRACT

Embodiments of the present disclosure provide methods for digital asset management. The method includes receiving an authorization event request from a user. The authorization event request includes authorization documents and information related to testifiers and legal authority. The method includes creating an authorization event for an authorization session. The method includes sending event details associated with the authorization event to participants of the authorization event. The method includes facilitating access to the authorization session for participants of the authorization event. Each participant of authorization event can be present for the authorization session either physically or virtually. The method includes provisioning an option to record the authorization session when the participants are present for the authorization session. The method includes sending a request to participants to sign the authorization documents either electronically or physically. The method includes terminating recording of the authorization session after the participants sign the authorization documents.

### TECHNICAL FIELD

Embodiments of the disclosure relate generally to digital asset management and, more particularly to, methods and systems for providing access control to digital content in a digital locker.

### BACKGROUND

Digital era has revolutionized communication between people of the world. With the advent of the Internet, users are digitizing information, such as, personal information, business information and storing the information in digital lockers to prevent data theft and easy retrieval of digital data. However, when a user is unable to access the digital locker due to health condition or death, the digital locker is not easily accessible by custodians to retrieve digital information from the digital locker.

In use, when the user (also referred to as ‘a testator’) creates a document for his digital locker and assigns custodians (also referred to as ‘caretaker’ or ‘assignee’) who are provided authorized access to the digital locker in certain circumstances, the document signing procedure requires physical presence of the user, one or more witnesses and a notary to be physically present at the same geographical location. Typically, the law requires the notary and the witnesses to see the testator signing the document. This makes the document signing process even more complex to bring together all the people (the testator, the witnesses and the notary) at the same instant. Further, the process of accessing and retrieving digital content from the digital locker by the authorized custodians when the user is no longer alive or able to perform his/her normal duties is cumbersome.

Currently, disbursement of digital content in the digital locker to the custodians is a cumbersome process requiring legal examining of medical information and health condition of the user. Further, such processes are manually performed with absolutely no granular access control of the digital locker to the custodians. Furthermore, such processes do not provide updates or alerts from the user or the custodians.

In light of the above discussion, there is a need for an automated digital asset management that provides enhanced signing process of documents, custodian assignment with restricted access controls and easy digital asset disbursement to the custodians.

### SUMMARY

Various embodiments of the present disclosure provide methods and systems for digital asset management.

In an embodiment, a method is disclosed. The method includes receiving, by a processor, an authorization event request from a user. The authorization event request comprising one or more authorization documents and information related to one or more testifiers and a legal authority. The method also includes upon receiving the authorization event request, creating, by the processor, an authorization event for an authorization session. The method includes sending, by the processor, authorization event details associated with the authorization event to participants of the authorization event. The participants of the authorization event include the user, the one or more testifiers and the legal authority. The authorization event details include at least an authorization session information and access credentials for the authorization session. The method also includes facilitating, by the processor, access to the authorization session for participants of the authorization event either physically or virtually via respective electronic devices. The method includes provisioning, by the processor, an option for the legal authority to record the authorization session when the participants are present for the authorization session. The method further includes verifying, by the processor, identity of the participants of the authorization event. The method includes sending, by the processor, a request to the participants to sign the one or more authorization documents either electronically or physically. The method further includes terminating, by the processor, recording of the authorization session after the participants sign the one or more authorization documents. The method includes storing, by the processor, the recording of the authorization session and the one or more authorization documents.

In another embodiment, a server system is disclosed. The server system includes a memory configured to store instructions and a processor configured to execute the instructions stored in the memory and thereby cause the system to perform a method. The method includes receiving, by a processor, an authorization event request from a user. The authorization event request comprising one or more authorization documents and information related to one or more testifiers and a legal authority. The method also includes upon receiving the authorization event request, creating, by the processor, an authorization event for an authorization session. The method includes sending, by the processor, authorization event details associated with the authorization event to participants of the authorization event. The participants of the authorization event include the user, the one or more testifiers and the legal authority. The authorization event details include at least an authorization session information and access credentials for the authorization session. The method also includes facilitating, by the processor, access to the authorization session for participants of the authorization event either physically or virtually via respective electronic devices. The method includes provisioning, by the processor, an option for the legal authority to record the authorization session when the participants are present for the authorization session. The method further includes verifying, by the processor, identity of the participants of the authorization event. The method includes sending, by the processor, a request to the participants to sign the one or more authorization documents either electronically or physically. The method further includes terminating, by the processor, recording of the authorization session after the participants sign the one or more authorization documents. The method includes storing, by the processor, the recording of the authorization session and the one or more authorization documents.

In yet another embodiment, a method is disclosed. The method includes receiving, by a processor, an authorization event request from a user. The authorization event request includes information related to one or more participants and one or more authorization documents related to a digital locker of the user. The digital locker includes one or more digital contents. The method also includes upon receiving the authorization event request, creating, by the processor, an authorization event for an authorization session. The method includes sending, by the processor, authorization event details associated with the authorization event to the one or more participants of the authorization event. The authorization event details include at least an authorization session information and access credentials for the authorization session. The method includes facilitating, by the processor, access to the authorization session for the participants of the authorization event. Each participant of the participants of the authorization event can be present for the authorization session either physically or virtually. The method further includes recording, by the processor, the authorization session when the participants are present for the authorization session. The method includes sending, by the processor, a request to the participants to sign the one or more authorization documents either electronically or physically, wherein (1) a participant participating in the authorization session virtually signs the one or more authorization documents electronically; and (2) a participant participating in the authorization session physically signs the one or more authorization documents physically. The method includes terminating, by the processor, recording of the authorization session after the participants sign the one or more authorization documents. The method further includes storing, by the processor, the recording of the authorization session and the one or more authorization documents in the digital locker. The method includes accessing, by the processor, the one or more authorization documents to identify at least one custodian for the digital locker of the user. The method also includes facilitating, by the processor, registration of the at least one custodian with the digital locker of the user. The method further includes upon registration of the at least one custodian, facilitating, by the processor, receipt of a user preference input from the user for assigning access control to the at least one custodian, the access control defining a degree of access to the digital locker of the user.

### BRIEF DESCRIPTION OF THE FIGURES

For a more complete understanding of example embodiments of the present technology, reference is now made to the following descriptions taken in connection with the accompanying drawings in which:

FIG. 1 is an illustration of an environment, where at least some example embodiments can be practiced;

FIG. 2 is an example flow diagram of a digital locker lifecycle, in accordance with an example embodiment;

FIG. 3 is a flow diagram of a sequence of steps for event recording when a testator signs a document, in accordance with an example embodiment;

FIGS. 4A and 4B are a flow diagram of an example method depicting management of custodians associated with a digital locker, in accordance with an example embodiment;

FIGS. 5A and 5B are a flow diagram of an example method of a check-in process for automatic checking of a life event of testator and custodians, in accordance with an example embodiment;

FIG. 6A is a flow diagram of an example method of beneficiary allocation, in accordance with an example embodiment.

FIG. 6B is a flow diagram of an example method for digital locker disbursement process, in accordance with an example embodiment;

FIG. 7A is a flow diagram of an example method for medical proxy management, in accordance with an example embodiment;

FIG. 7B is a flow diagram of an example method for medical proxy management, in accordance with another example embodiment;

FIG. 8 is an example scenario for facilitating disbursement of digital locker, in accordance with an example embodiment;

FIG. 9A illustrates a user interface displayed to a user for managing custodians, in accordance with an example embodiment;

FIG. 9B illustrates a user interface displayed to the user for assigning access controls to the custodians of the digital locker, in accordance with an example embodiment;

FIG. 9C illustrates a user interface displayed to the user for managing check-in notifications of the user and the custodians, in accordance with an example embodiment;

FIG. 10A is a user interface depicting a live sign in application, in accordance with an example embodiment;

FIG. 10B is a user interface depicting Medical Power of Attorney (MPoA) for identifying assignees, in accordance with an example embodiment;

FIG. 10C is an example representation of a notification sent to an assignee, in accordance with an example embodiment;

FIG. 11 is a flow diagram of a method for recording an authorization event when a user receives a shipment, in accordance with an example embodiment;

FIG. 12 is a flow diagram of a method for managing digital assets, in accordance with an example embodiment;

FIG. 13 is a block diagram of an electronic device, in accordance with an example embodiment; and

FIG. 14 is a block diagram of the server of FIG. 1, in accordance with an example embodiment.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. In other instances, systems and methods are shown in block diagram form only in order to avoid obscuring the present disclosure.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

### OVERVIEW

Various example embodiments of the present disclosure provide methods and systems for managing digital assets. The term ‘managing’ includes assigning custodians, providing access control to the custodians, authorizing the assignment of the custodians, digital event recording and management of the testator signing authorization documents, check-in process of custodians and the testator, and disbursement of digital contents in the digital locker.

Digital contents of the digital locker (of a user) can be accessed by custodians assigned by the user. The custodians are legally assigned by the user who authorizes the custodians to access the digital locker by signing authorization documents in presence of notary and witnesses. The signing of the authorization documents in presence of notary and witnesses can be done remotely or physically or a combination of remote and physical, and a live-sign event is created, recorded and stored in the digital locker for future reference. Further, the user assigns a degree of access to the digital locker for the custodians. The user or the system (application) also initiates a check-in process to ensure that the custodians are actively participating in securing the digital locker. The user or system (application) can decide frequency for the check-in process. Additionally, the user assigns medical proxy by providing Medical Power of Attorney (MPoA) to one or more assignees who can make healthcare decisions for the user when he/she is incapacitated. The digital locker can be disbursed, upon following the verification and validation process, to one of the beneficiaries when at least one custodian raises a claim intimating a disbursement team that the user is incapacitated or no longer alive. The disbursement team analyzes the claim raised by the at least one custodian to disburse contents of the digital locker as indicated by the user. The processes involved in event recording of live-sign event, custodian access management, check-in process of custodians, medical proxy management and digital locker disbursement process can also be performed using technologies such as, but not limited to, cloud technologies, block chain technologies and smart contracts.

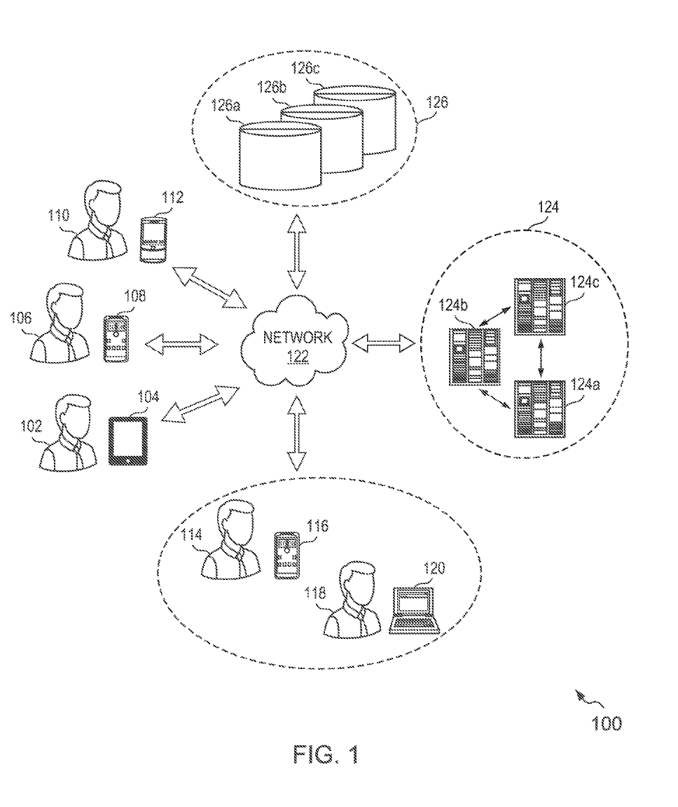

FIG. 1 is an example representation of an environment 100 related to at least some example embodiments of the present disclosure. An example representation of the environment 100 is shown depicting a communication network (e.g., a network 122) that connects entities such a user 102, a notary 106, a witness 110, custodians 114, 118, servers 124a, 124b, 124c (hereinafter referred to as server 124) and databases 126a, 126b, 126c (hereinafter referred to as database 126). It shall be noted that there may be multiple witnesses and one witness 110 is shown for the sake of simplicity and example purposes only. In an embodiment, the servers 124a, 124b, 124c and the databases 126a, 126b, 126c are distributed and decentralized. The network 122 may be centralized or decentralized network or may comprise a plurality of sub-networks that may offer a direct communication between the entities or may offer indirect communication between the entities. Examples of the network 122 include, but are not limited to, the Internet, local area network (LAN), wide area network (WAN), wireless, wired, and the like.

The user 102, the notary 106, the witness 110 and the custodians 114, 118 may have one or more communication devices for communicating among themselves. In an example, the user 102 has a device 104, the notary 106 has a device 108, the witness 110 has a device 112 and the custodians 114 and 118 have devices 116, 120, respectively. Examples of the devices 104, 108, 112, 116, 120 are not limited to mobile phones only, and the devices 104, 108, 112, 116, 120 may take examples of any portable electronic device (e.g., laptops, smartphones and tablets) having cellular communication capabilities. For instance, the devices 104, 108, 112, 116 and 120 may be equipped with subscriber identity module (SIM) or Removable User Identity Module (R-UIM) to enable cellular communication.

The user 102 has digital contents recorded or stored in a digital locker. The digital contents in a digital locker correspond to images, music and documents comprising personal and business information of the user 102. In an embodiment, the digital contents of the digital locker are remotely stored in the server 124 and/or the database 126. The user 102 provides authorized access to at least a part of the digital locker to custodians 114, 118. The custodians 114, 118 are authorized to access at least a part of the digital locker based on a degree of access provided by the user 102 via the devices 116, 120, respectively. In an embodiment, the user 102 provides access to the digital locker legally by signing one or more authorization documents in a virtual presence of the notary 106 and the witness 110. It must be noted that the witness 110 and the notary 106 are shown for example purposes only and more than one witness and notary may be required for signing the one or more authorization documents. Moreover, the authorization documents may be signed either electronically, physically or a combination of virtual and physical presence of the user 102, the notary 106 and the witness 110. For example, the user 102 may be present in a remote location and may sign authorization documents electronically whereas the notary 106 and the witness 110 may be physically sign the authorization document in the virtual presence of the user 102 (also referred to as ‘a testator 102’).

The user 102, the notary 106 and the witness 110 may access a tool/platform (e.g. a live-sign application), on their respective devices, facilitated by the server 124 for creating an authorization event for an authorization session. The authorization session includes a process of signing the authorization documents by the user 102, the witnesses 110 and the notary 106 as part that may be recorded and stored in the digital locker. The authorization session corresponding to the authorization event may be an event in which the user 102 may assign custodians 114, 118 and/or assignees for the digital locker of the user 102. The assignees of the digital locker can access the digital contents of the digital locker when the user 102 is incapacitated/dead. The custodians 114 and 118 may also access the live-sign application on their respective devices or may be present physically in the room. In a non-limiting example, the live-sign application may be a web application. In another example, the live-sign application may be a mobile application. The devices 104, 108, 112, 116, 120 may access an instance of the live-sign application from the server 124 for installing on the devices 104, 108, 112, 116, 120 using application stores associated with Apple iOS™, Android™ OS, Google Chrome OS, Symbian OS®, Windows Mobile® OS, Windows Phone, BlackBerry® OS, Embedded Linux, web OS, Palm OS® or Palm Web OS™, and the like. Alternatively, the live-sign application may be installed as a stand-alone application on a stand-alone device, such as the devices 104, 108, 112, 116, 120.

When the user 102 requests for an authorization session in which the one or more authorization documents corresponding to the digital locker are to be signed by the user 102, the notary 106 creates the live-sign event and sends requests to participants, such as, the witness 110, the user 102 and optionally the custodians 114, 118 to register for the authorization event. The requests to the participants include information pertaining to the authorization event and log in details for the authorization event. For instance, the notary 106 initiates a video conferencing to start the authorization session and the participants (the witness 110 and the user 102) log in to participate in the authorization session via respective devices. In an embodiment, the notary 106 verifies identity of the participants (the witness 110, the user 102 and optionally the custodians 114, 118) of the authorization event. It must be noted that the notary 106 can verify the identity of the participants in the authorization event by multiple ways, such as but not limited to identity cards, facial recognition, biometric fingerprints, voice and retinal scan. It must be noted that the authorization event does not mandate remote participation of all participants (notary, custodians, witnesses, testators) and one or more participants (notary, custodians, witnesses, or testators) can be physically present in the room while recording the authorization event. In an example, even all of the participants (notary, custodians, witnesses, testators) may be physically present in the room for the authorization event when the authorization session event is recorded by the notary 106.

In an embodiment, the notary 106 initiates recording of the authorization session. The notary 106 opens the one or more authorization documents to be signed by the user 102 in virtual or physical presence of other participants. The testator 102 and the witness 110 electronically or physically sign the authorization documents in the virtual or physical presence of the notary 106. The notary 106 signs the authorization documents upon verification of details and the signature acquired from the testator 102 and the witness 110. The notary 106 terminates the recording of the authorization session and saves the authorization session in the digital locker of the user 102. Further, the notary saves a copy of the authorization session in the server 124 and the database 126 for future reference. The notary 106 sends at least one of a physical copy or an electronic copy of the authorization documents (signed by the testator 102, the witness 110 and the notary 106) to the user 102 and updates the custodians 114, 118 of the authorization event.

In an embodiment, the user 102 identifies and assigns custodians, such as the custodians 114 and 118. The custodians 114 and 118 are required to be registered with the digital locker for accessing the digital contents. Further, the degree of access to the digital locker for the custodians 114 and 118 is based on a user preference input set by the user 102 as at least one of a contribute mode, a restricted mode, a read-only mode, an edit mode, and a full access mode. The contribute mode allows the custodians 114 and 118 to add digital content/files to the digital locker but no provisions exist for editing/deleting digital contents in the digital locker. The custodians 114 and 118 are denied access (or have no access) to the digital locker in the restricted mode unless they provide a proof that the user 102 is unable to perform his/her duties and the digital contents of the digital locker are disbursed to the custodians 114 and 118. The read-only mode permits the custodians 114 and 118 to view the digital contents of the digital locker and the full access mode allows the custodians 114 and 118 unrestricted access to all digital contents of the digital locker. The custodians 114 and 118 can delete, remove and edit digital contents from the digital locker in the full access mode. The edit mode permits the custodians 114 and 118 to edit the digital contents of the digital locker.

In an example embodiment, the custodians 114 and 118 participate in a check-in process that is initiated by the user 102 or by the system (Application). The check-in process ensures that the user 102 and/or custodians 114 and 118 are actively involved in securing the digital locker. The user 102 or the system (Application) creates the check-in process and presets options for the check-in process, such as, frequency of alerts and number of electronic reminders. The check-in process is an automatic process that runs on the server 124 and promptly notifies the user 102 and/or the custodians 114, 118 upon violation of rules in the check-in process. For example, the user 102 or the system (Application) may set a weekly check-in trigger for sending a check-in notification to the user 102 and the custodians 114, 118. The user 102 and the custodians 114, 118 have to respond to the check-in notification that is sent every week. Whenever the user 102 or the custodians 114, 118 respond to the check-in trigger by checking in, a data log is updated with a time stamp that corresponds to a time in which either the user 102 or the custodians 114, 118 checked in. For example, the weekly check-in trigger may initiate a check-in notification for the user 102 and custodians 114, 118 on Wednesday at 9 AM, the user 102 may respond to the check-in notification by checking-in at 9:30 AM and custodian 114 may check-in at 10 AM. The data log is updated to include check-in information, such as, the user 102 at 9 AM and the custodian 114 at 10 AM.

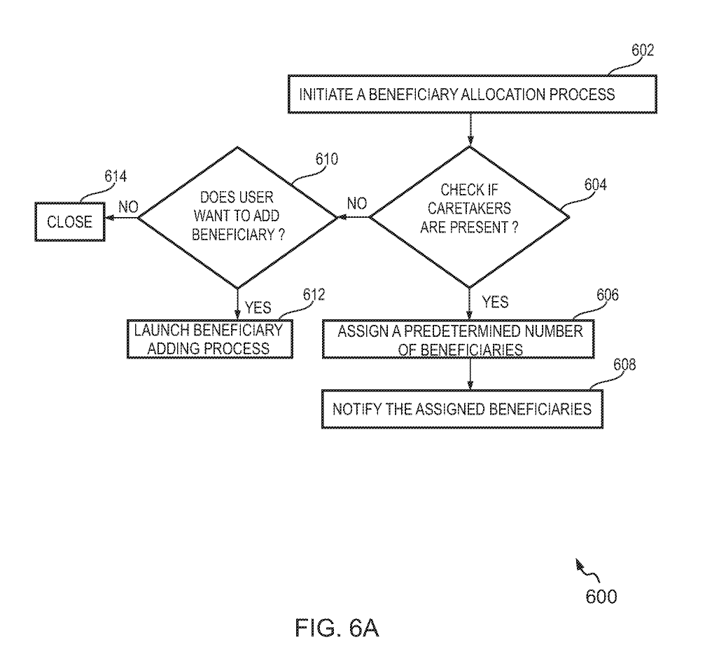

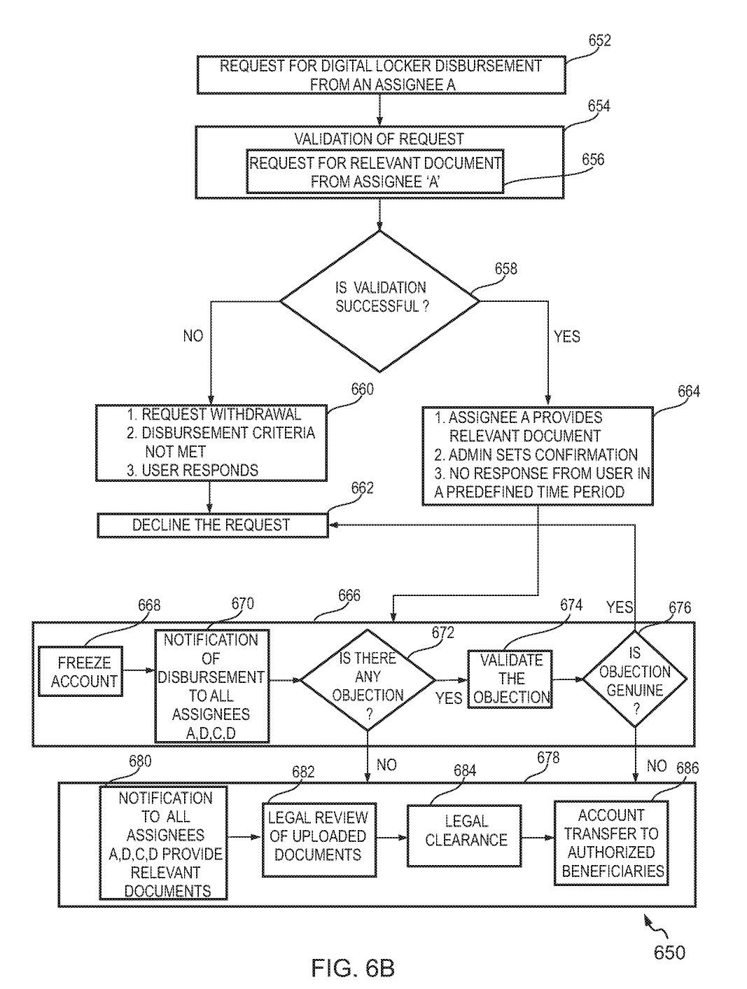

The user 102 or the system (Application) can set the number of violations. In an example, if the user 102 or the system (Application) sets the number of violations to 3 violations and, if the user 102 does not respond to the check-in notifications sent to the user 102 for 3 times, the custodians (the custodians 114, 118) are informed about the user 102 violation for the check-in notification set by the user 102. In such cases, the custodians 114, 118 can take further steps to ensure if the user violation for the check-in notification is just a false alarm or a real problem. For instance, if the user 102 is incapacitated and unable to respond to check-in notifications (determined by offline/manual methods), the custodians 114, 118 can raise a claim and request for access to the digital locker they were nominated for. The claim raised by the custodians 114, 118 and request to access the digital locker of the user 102 is received by the server 124. This request to access the digital locker of the user 102 triggers a locker disbursement process that is further explained with reference to FIG. 6B.

If any of the custodians 114, 118 fail to respond to the check-in trigger set by the user 102 or the system (Application), the server 124 resends e-reminders to the custodian who failed to respond. The user 102 or the system (Application) also sets limit on number of maximum reminders to be sent to a custodian who fails to respond to the check-in trigger. If the limit on maximum e-reminders sent by the server 124 is exhausted, the server 124 notifies the user 102 of the violation by the custodian. For instance, if the custodian 118 fails to respond for the check-in trigger with-in 48 hours or a system set limit of the check-in notification and the custodian does not respond to the reminders (maximum reminders) sent by the server 124, the user 102 is notified of the violation by the custodian 118. The user 102 can choose to either retain the custodian 118 or remove the custodian 118 for the violation. If the user 102 chooses to remove the custodian 118, a notification is sent to the other custodian 114 that the custodian 118 has been released from his/her duty. It must be noted that the user 102 can define/set the check-in trigger at any frequency for the custodians.

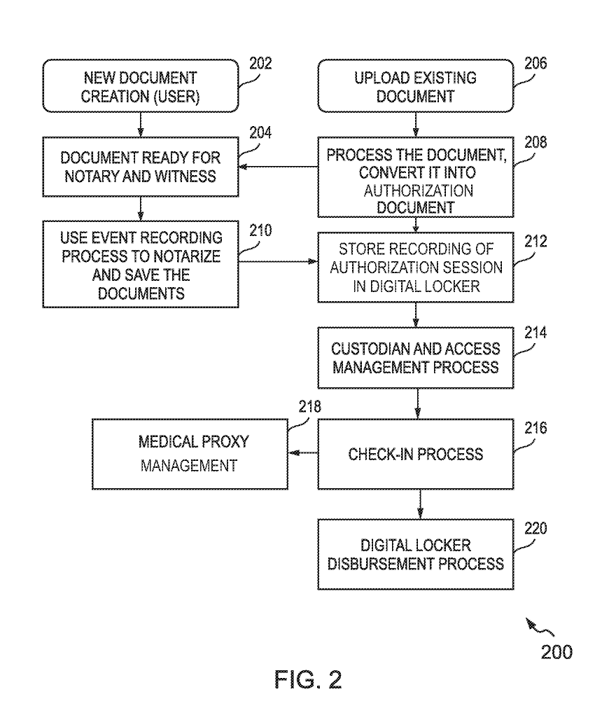

FIG. 2 is a flow diagram 200 of a digital locker lifecycle, in accordance with an example embodiment. The sequence of operations of the method 200 need not to be necessarily executed in the same order as they are presented. Further, one or more operations may be grouped together and performed in form of a single step, or one operation may have several sub-steps that may be performed in parallel or in sequential manner.

At operation 202, a testator for example the user 102 creates a new document. The new document is an authorization document in which the user 102 authorizes one or more custodians (e.g., the custodians 114, 118) as assignees for his/her digital locker. The authorization document comprises information pertaining to custodians 114, 118, degree of access offered to each custodian and/or medical proxies of the user 102. At operation 204, the authorized documents are prepared in a legal format and are prepared for view by one or more witnesses (e.g., the witness 110), a notary 106 and the user 102. The authorized documents are uploaded and prepared for view in a live-sign application (also referred to as ‘a live-sign portal’).

Additionally or alternatively, at operation 206, any existing document pertaining to the authorization document can also be uploaded to the live-sign portal. At operation 208, the existing document is processed and converted so as to be appended with the authorization document created by the user 102.

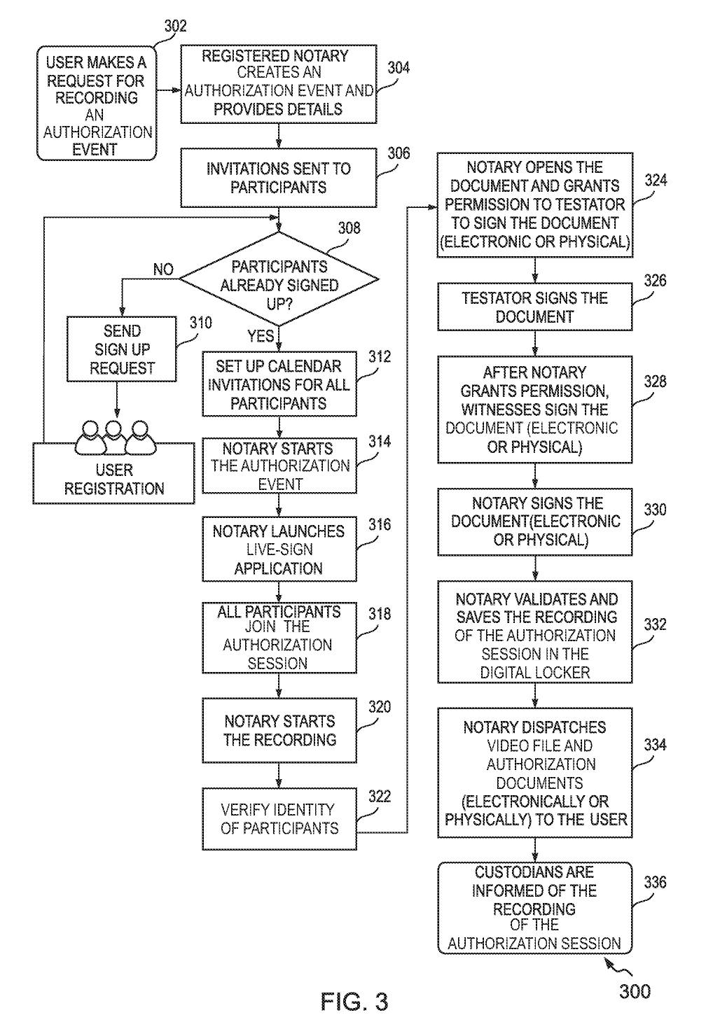

At operation 210, the notary 106 creates an authorization event for the user 102 (the testator) to sign the authorization documents and the existing documents in virtual or physical view of the witnesses (e.g., the witness 110). The notary 106 shares the authorization event details of the authorization event with the user 102 and the one or more witnesses such as the witness 110. The authorization event details include authorization session information and access credentials for the user 102 and the one or more witnesses. The authorization session information may include venue details, date and time of the authorization event for the user 102 and/or the one or more witnesses participating in the authorization event physically. The access credentials may include log in information such as user name, access code, web link and the like for virtually participating in the authorization event. Electronic reminders (e-reminders or reminders) for the authorization event are automatically sent by the server 124 to the participants (the testator 102, the notary 106 and the witness 110). The notary 106, the user 102 and the witness 110 log in to the live-sign portal for joining an authorization session. For instance, a video conferencing is set up between the notary 106, the user 102 and the one or more witnesses (e.g., the witness 110) for viewing the authorization session indicated by the authorization event. The notary 106 verifies identity of the user 102 and the witness 110 prior to recording the authorization session. In an embodiment, the notary 106 initiates recording of the authorization session upon displaying the authorization document and the live-sign document (existing documents) for the user 102 and the witness 110 and requests the user 102 to sign the authorization documents. The witness 110 is then requested to sign the authorization documents. The notary 106 verifies the signatures and signs the authorization documents. It must be noted that the participants (notary, custodians, witnesses, testators) of the authorization session may sign either electronically if the participants connect remotely for the authorization event or may sign physically if the participants are present with the notary 106 during the authorization session that is recorded by the notary 106. The notary 106 terminates recording of the authorization event. The sequence of steps for recording the authorization session when a testator 102 signs the authorization documents is further explained with reference to FIG. 3. It must be noted that the authorization event does not mandate virtual presence of all participants (notary, custodians, witnesses, testators) and one or more participants (notary, custodians, witnesses, testators) can be physically present in the room while recording the authorization session. The live-sign process can be offered as a standalone service to other users who may or may not be part of the digital locker system. Essentially, live-sign process can be extended to be a video notary process by itself.

For instance, any of the parties such as the testator, the witnesses can also be physically present in same room as the notary when the testator signs the authorization documents electronically from a remote location. In an example, the notary and a witness 1 can be in the same room, while another witness 2 and the testator can join remotely in the authorization event via video conferencing.

At operation 212, the authorization session recorded by the notary 106 is stored in the digital locker of the user 102. The digital locker of the user 102 is hosted and maintained in the server 124. In an embodiment, a digital copy of the authorization documents and the live-sign documents are stored in the digital locker.

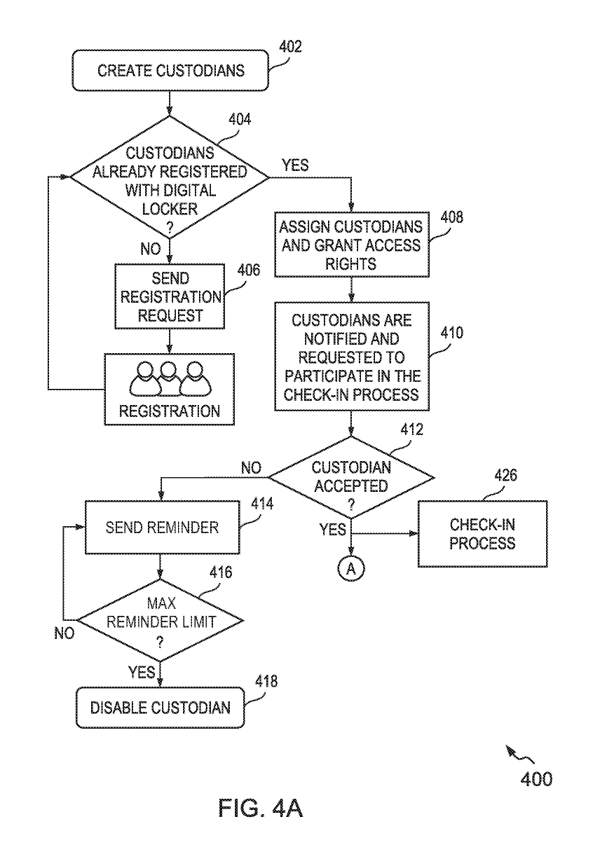

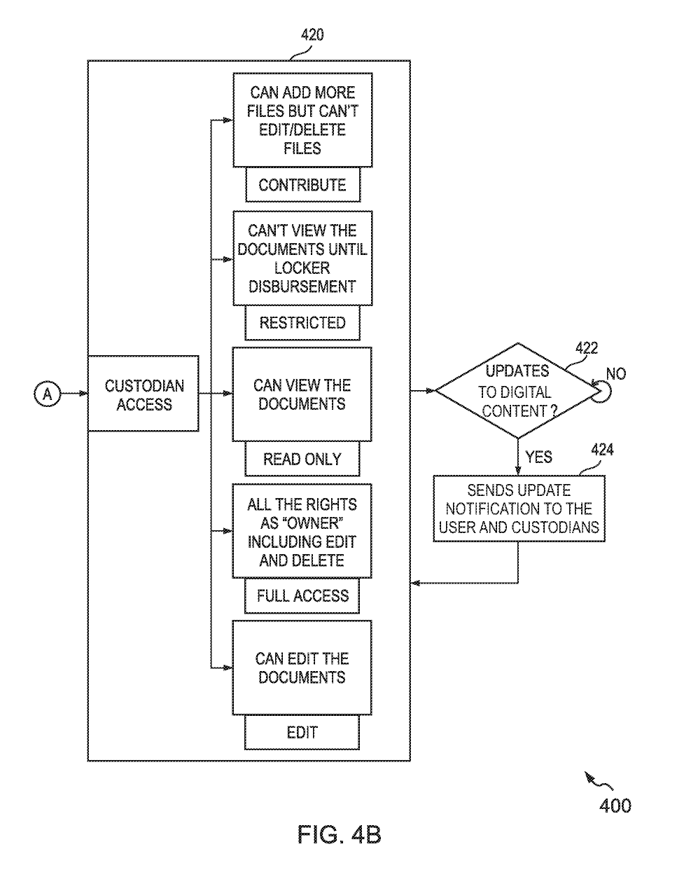

At operation 214, custodian and access management process is performed. The one or more custodians 114 and 118 identified by the user 102 are registered with the server 124 comprising the digital locker and the user 102 assigns various degree of access to the digital locker for each custodian 114 and 118. In an embodiment, the user 102 assigns at least one of a contribute mode, a restricted mode, a read-only mode, an edit mode and a full access mode to each custodian 114 and 118. The contribute mode allows the custodians 114, 118 to add digital content to the digital locker but not edit/delete digital contents in the digital locker. The custodians 114, 118 have no access to the digital locker in the restricted mode unless they provide a proof that the user is unable to perform his/her duties and the digital contents of the digital locker are disbursed to the custodians 114, 118. The read-only mode permits the custodians 114, 118 to view the digital contents of the digital locker. The full access mode allows the custodians 114, 118 unrestricted access to all digital contents of the digital locker. The custodians 114, 118 can delete, remove and edit digital contents from the digital locker in the full access mode. The edit mode permits the custodians 114 and 118 to edit the digital contents of the digital locker. Custodian management and access management of digital locker for the custodians 114, 118 is further explained with reference to FIGS. 4A-4B.

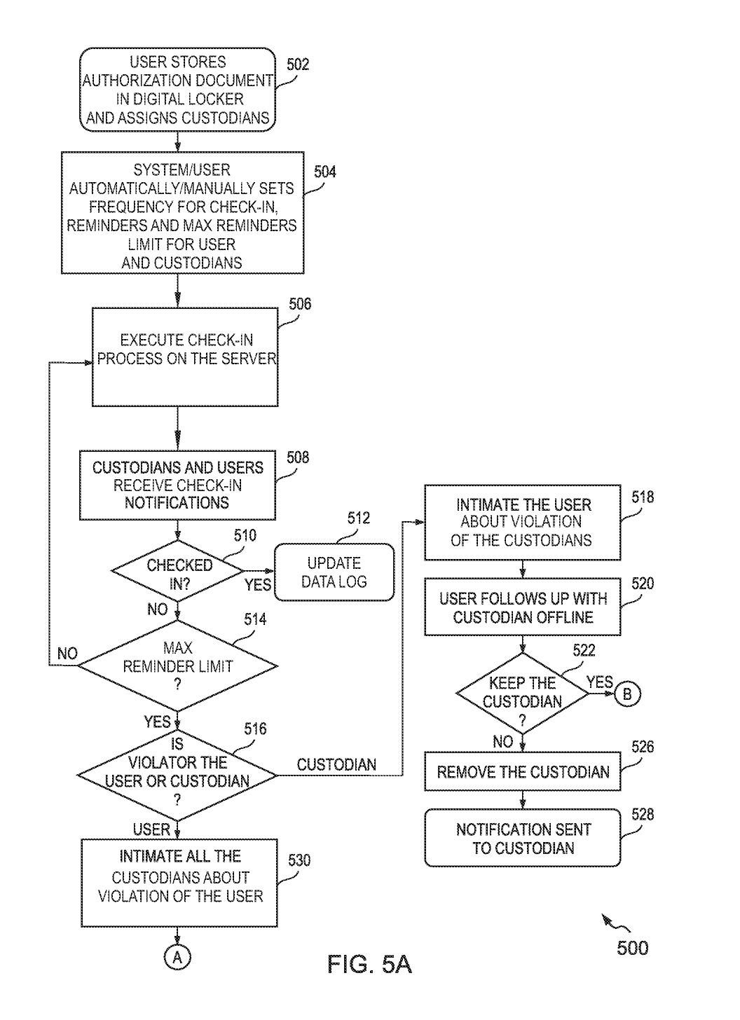

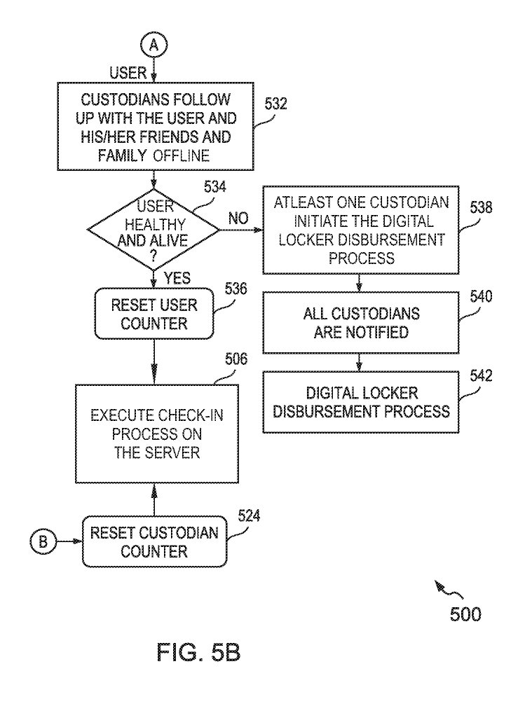

At operation 216, a check-in process is created and initiated by the user 102 or the system (Application). The user 102 or the system (Application) sets a check-in trigger which requires the one or more custodians 114, 118 and the user 102 to respond to the check-in trigger. The frequency of the check-in trigger and maximum reminder limit for custodians/the user who fail to respond to the check-in trigger are set by the user 102 or the system (Application). For example, if the user 102 does not respond to the check-in trigger for 3 times or as set by the system (Application), the one or more custodians 114, 118 are informed about the user's violation for the check-in trigger. The custodians 114, 118 can probe to determine if the violation is a false alarm or a real problem. The custodians 114, 118 contact the user 102 offline to determine inability of the user 102 (if any). If the custodians 114, 118 determine that the user 102 is incapacitated to perform normal duties, the custodians 114,118 raise a claim (also referred to as ‘a disbursement request’) and notify the server 124 for the digital locker disbursement process (shown in block 220). Automatic checking of a life event (check-in process) of a testator (e.g. the user 102) and the custodians 114, 118 is further explained with reference to FIGS. 5A-5B.

At operation 218, medical proxy management is performed. The user 102 may grant permission/access to public and/or a medical facility, such as a hospital or a clinic to make his/her medical proxies available online in the server 124. The server 124 may communicate with one or more servers that are responsible for storing and maintaining the user's medical proxies, in order to retrieve the user's medical proxies. In an embodiment, the user 102 assigns custodian(s) 114 and/or 118 to access the medical proxies without a disbursement process. The user 102 can also sign up to make the medical proxy available online to healthcare institutions/hospitals to ensure that proper decisions can be taken for disbursing the digital locker without causing any additional delays. For instance, when the user 102 is incapacitated, healthcare providers assess health condition information of the user 102 and retrieve the medical proxy for making a healthcare decision.

At operation 220, a digital locker disbursement process is performed. A disbursement team analyses a disbursement request raised by the custodian(s) 114 and/or 118 for disbursement of the digital locker. The disbursement team conducts a validation and verifications process, notifies one or more custodians 114 and/or 118 about the disbursement request, user's inability and the disbursement request is raised by the custodians 114 and/or 118. Further, the disbursement team schedules a disbursement authorization event for disbursing the digital locker upon verification of the claim and notifies the custodians 114, 118 of the disbursement authorization event with disbursement event details, such as, disbursement authorization session information and registration information. The disbursement authorization session information includes venue details, date and time of the disbursement authorization event and the registration information may include registration confirmation to indicate physical/virtual presence of the user 102 and/or the one or more witnesses. In some embodiments, the user 102 and/or the one or more witnesses may be provided access credentials such as login details for the digital locker disbursement event. The disbursement team verifies identity of the custodians 114 and/or 118 participating in the digital locker disbursement event. The disbursement team displays digital locker disbursement documents and requests the custodians 114, 118 to electronically or physically sign the digital locker disbursement documents. The custodians 114, 118 sign (physically/electronically) the digital locker disbursement documents upon verifying the details in the digital locker disbursement documents. The digital locker disbursement event is recorded by the disbursement team and stored as a record for future reference. The digital locker disbursement process is further explained in detail with reference to FIG. 6B. It must be noted that the digital locker disbursement process does not mandate remote participation of all participants (disbursement team, custodians 114, 118) and custodians can be physically present in same room as disbursement team while recording the digital locker disbursement event.

FIG. 3 is a flow diagram of a method 300 for recording an authorization session when a testator 102 signs the documents, in accordance with an example embodiment. The operations of the method 300 are performed by the server in conjunction with respective devices of the testator, custodians, notary and witnesses. The sequence of operations of the method 300 need not be necessarily executed in the same order as they are presented. Further, one or more operations may be grouped together and performed in form of a single step, or one operation may have several sub-steps that may be performed in parallel or in sequential manner.

At operation 302, the method 300 includes receiving a request from the user 102 for recording an authorization event. The user 102 requests the notary 106 to create the authorization event in which the user 102 (testator) electronically or physically signs authorization documents that comprise details of digital locker of the testator 102, custodian assignments, degree of access to the digital locker assigned to each of the custodians 114, 118 and medical proxies of the testator 102.

At operation 304, the method 300 includes creating the authorization event for an authorization session, by the notary 106 and providing authorization event details. At operation 306, the method 300 includes sending an invitation including the authorization event details such as, authorization session information and access credentials to participants of the authorization event. The participants of the authorization event are the testator 102, one or more witnesses (e.g., the witness 110) and the notary 106. In some example embodiments, the custodians 114, 118 may also be the participants of the authorization event. It shall be noted that, in at least one example embodiment, the user/testator 102 has to initiate sending invitations to the one or more witnesses, such as the witness 110. Further, the user 102 has to send a request to the notary 106 to create the authorization event. The invitation sent to the participants includes authorization session information and access credentials for the authorization session. The authorization session information may include venue details, date and time of the authorization session. The access credentials may include login information for joining the authorization session virtually such as, user name, password, web link. For instance, the authorization session may be conducted via a video conference and the participants are provided with login information, such as, username and password to join the video conference.

At operation 308, the method 300 includes checking if the participants have signed up for the authorization session. This ensures that all participants are aware of the authorization event and ensure that they will be available for the authorization session. If a participant has not signed up for the authorization session as per the details of the authorization event, operation 310 is performed else operation 312 is performed.

At operation 310, the method 300 includes sending a sign up request to the participants who have not yet signed up for the authorization event set up by the notary 106. For instance, a witness, such as the witness 110 who has not yet signed up receives the sign up request. The witness follows a step wise process to complete the sign up for the authorization event that may require the witness to confirm his/her participation in the authorization session.

At operation 312, the method 300 includes sending calendar invitations to the participants of the authorization event. The participants (the notary 106, the witness 110 and the testator 102) receive a notification with calendar invitations indicating the authorization event details of the authorization session. For instance, a day before the authorization event is scheduled; all participants receive the notification comprising the calendar notification of date and time of the authorization session.

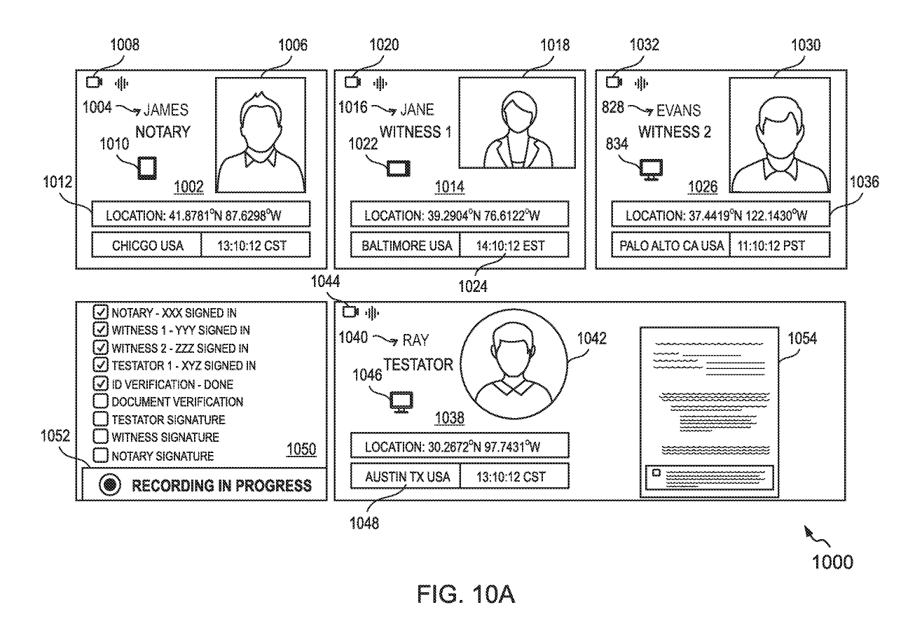

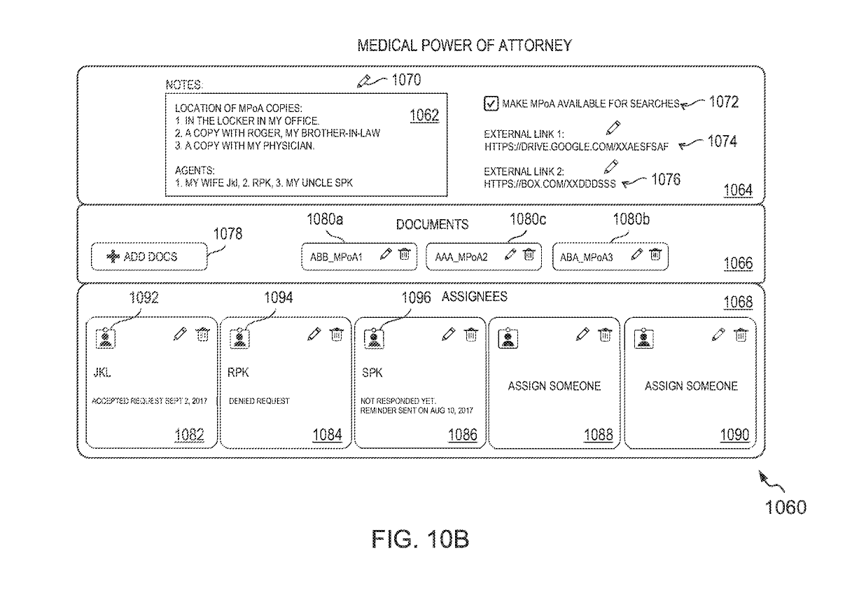

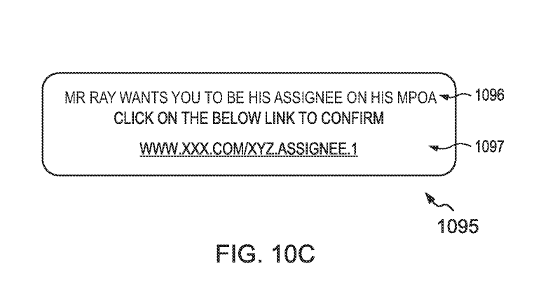

At operation 314, the notary 106 starts the authorization session based on the authorization event details provided to the participants. At operation 316, the notary 106 launches the live-sign application. The live-sign application includes authorization documents prepared by the notary 106 as directed/requested by the testator 102. Further, the live-sign application displays images of the participants and their corresponding locations obtained from location services, such as, Global Positioning Services (GPS). A user interface depicting the live-sign application is explained in detail with reference to FIG. 10A.

At operation 318, the participants join the authorization session. The participants join the authorization session using the log in details provided by the notary 106 who created the authorization event in the live-sign application. In an embodiment, the authorization session is a video conference call. When the notary 106 creates the authorization event on the live-sign application, the server 124 provides a web link and log in credentials to each participant which the participants use to join the video conference (authorization session).

At operation 320, the notary 106 initiates recording of the authorization session. At block 322, identity of the participants is verified by the notary 106. The notary 106 verifies identity of the participants by asking the participants to display identity proofs such as driving licence etc. Alternatively, facial recognition, biometric fingerprint verification, voice verification or retinal scan methods can be implemented to verify the identity of the participants. It must be noted that the notary 106 can verify identity of the participants using multiple verification methods prior to electronically signing the authorization documents.

At operation 324, the notary 106 opens the authorization documents to be viewed by all the participants and grants permission to the testator 102 to electronically/physically sign the authorization documents in presence of the witnesses 110. The testator 102 can verify details of the authorization documents and then electronically sign the authorization documents as shown in operation 326. It must be noted that if the testator 102 is physically present along with the notary 106, the testator 102 can physically sign the authorization documents.

At operation 328, the witnesses (e.g., the witness 110) electronically or physically sign the authorization documents upon the notary 106 granting them permission. It must be noted that if the witnesses are physically present along with the notary 106, the witnesses can physically sign the authorization documents.

At operation 330, the notary 106 signs the authorization documents either electronically or physically. The notary 106 makes final remarks to the participants of the authorization event and terminates recording of the authorization session.

At operation 332, the notary 106 validates the authorization session that was recorded and stores a video file corresponding to the authorization session in the digital locker of the testator 102. At operation 334, the video file corresponding to the authorization event is sent to the user 102. The notary 106 dispatches a copy of the authorization documents signed by the testator 102, the witnesses and the notary 106 to the testator 102 either electronically or physically.

At operation 336, the custodians 114, 118 are updated about the recording of the authorization event. This ensures that the custodians 114, 118 are aware of their responsibilities to ensure safety of the digital locker of the user 102.

FIGS. 4A and 4B are a flow diagram of an example method 400 depicting management of custodians of digital locker, in accordance with an example embodiment. The sequence of operations of the method 400 need not be necessarily executed in the same order as they are presented. Further, one or more operations may be grouped together and performed in form of a single step, or one operation may have several sub-steps that may be performed in parallel or in sequential manner.

At operation 402, the user 102 creates assignees (e.g., the custodians 114, 118) for his/her digital locker. At operation 404, it is checked if each assignee created for the digital locker by the user 102 is registered with the digital locker. If any of the assignees are not registered with the digital locker of the user 102, operation 406 is performed else operation 408 is performed.

At operation 406, a registration request is sent to the assignees that have been assigned by the user 102 but not registered with the digital locker of the user 102. For instance, if an assignee μl (e.g., the custodian 114) is not already registered with the digital locker located in the server 124, the server 124 sends a registration link to the assignee μl. It must be noted that the user 102 can only assign operation of a custodian to an assignee after they register with the digital locker.

In some example embodiments, the operations 404, 406 and registration of custodians are optional operations, or these may be performed in the background or a later point of time. In such example embodiments, when the user creates the assignees at operation 402, the method 400 performed by the system, proceeds directly to the operation 408.

At operation 408, the user 102 selects and assigns custodians 114,118 who are registered with the digital locker. For example, the assignee μl may be assigned as a custodian when the assignee μl registers with the digital locker of the user 102. The custodian assignment process indicates to the custodians 114,118 that they have been granted access to the digital locker. However, the user 102 defines degree of access provided to the custodians 114,118.

At operation 410, the server 124 notifies the custodians 114, 118 about their allocation (as custodians) and requests the custodians 114, 118 to participate in a check-in process. The user 102 presets a check-in trigger and the server 124 sends a check-in notification to the custodians 114, 118. The custodians 114,118 are requested to respond to the check-in notification from the server 124 to ensure that they are active participants in the digital locker.

At operation 412, the server 124 checks if all the custodians 114,118 have responded to the check-in notification. If a custodian has not responded to the check-in notification, operation 414 is performed else operation 420 is performed.

At operation 414, the custodian (who did not respond to the check-in notification) is alerted and requested to respond to the check-in notification. At operation 416, the server 124 checks if maximum reminder limit for a plurality of reminders to the custodian is exhausted. If the maximum reminder limit is reached and the plurality of reminders to the custodian are exhausted, and the custodian has still not responded to the check-in notification, then operation 418 is performed else operation 414 is performed.

At operation 418, the custodian (e.g., custodians 114 and/or 118) who did not respond to the check-in notification is disabled by the server 124. For instance, if limit of the maximum alert is set to be 3 times, the custodian will be alerted 3 times before the custodian may be disabled by the server 124.

At operation 420, custodians 114, 118 who responded to the check-in notification can access the digital locker based on the degree of access assigned by the user 102 to the custodians 114, 118. In an embodiment, the user 102 assigns at least one of a contribute mode, a restricted mode, a read-only mode, edit mode, and a full access mode to the custodians 114,118. The contribute mode allows the custodians 114, 118 to add digital content to the digital locker but not edit/delete digital contents in the digital locker. The custodians 114 and 118 have no access to the digital locker in the restricted mode unless they provide a proof that the user 102 is unable to perform his/her duties and the digital contents of the digital locker are disbursed to the custodians 114, 118. The read-only mode permits the custodians 114, 118 to view the digital contents of the digital locker and the full access mode allows the custodians 114, 118 unrestricted access to all digital contents of the digital locker. The custodians 114, 118 can delete/remove digital contents from the digital locker in the full access mode. The edit mode permits the custodians 114 and 118 to edit the digital contents of the digital locker.

At operation 422, the server 124 checks if the user 102 or any of the custodians 114, 118 have updated digital contents in the digital locker. If digital contents have been updated in the digital locker, operation at block 424 is performed else operation at block 420 is performed. At operation 424, the server 124 sends an update notification to the user 102 and the custodians 114, 118. The update notification indicates to the user 102 and the custodians 114, 118 that digital contents of the digital locker have been updated. For instance, if a custodian for example the custodian 114 who was assigned the full access mode, updates the digital locker with one or more images associated with the user 102. The server 124 recognizes the update in the digital locker by the custodian 114 and sends the update notification to the user 102 and other custodian 118 indicating that the custodian 114 has updated the digital locker with the one or more images. The method 400 continues with the operation 420.

At operation 426, the user 102 and the registered custodians 114, 118 who are granted access rights, participate in an auto check-in process. The auto check-in process is explained in detail with reference to FIGS. 5A and 5B.

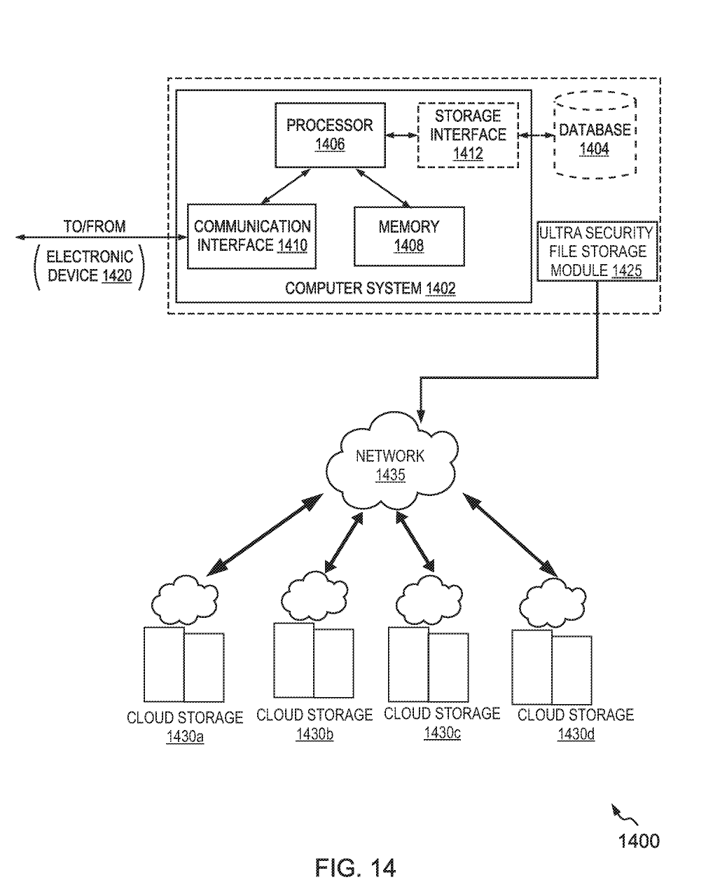

FIGS. 5A and 5B are a flow diagram of an example method 500 for automatic checking of a life event of testator and custodians, in accordance with an example embodiment. The operations of the method 500 may be carried out by a server such as the server 124 (or the server 1400 shown and explained with reference to FIG. 14). The sequence of operations of the method 500 may not be necessarily executed in the same order as they are presented. Further, one or more operations may be grouped together and performed in form of a single step, or one operation may have several sub-steps that may be performed in parallel or in sequential manner.

At operation 502, a user, such as the user 102, stores authorization documents in a digital locker and identifies custodians (such as the custodians 114,118) who can have access to digital contents of the digital locker and defines their degree of access to the digital locker (access rights). The custodians 114, 118 are notified about their allocation.

At operation 504, the user 102 (manually) or the system (Application) automatically creates and sets frequency for an automatic check-in process for the user 102 and the custodians 114, 118. The check-in process includes setting several attributes by the user 102 or by system, such as, frequency of check-in process, number of reminders (also referred to as ‘a plurality of reminders’), maximum reminder limit and people to receive check-in notifications. The check-in process ensures that the user and custodians are constantly reminded of their role, forcing them to actively acknowledge and participate in the health check process including the user. The check-in process helps alerting the custodians about the user if he fails to respond to the check-in process.

At operation 506, the server 124 executes the check-in process based on the frequency set by the user/system and looks for events that can trigger a violation. The check-in process is an automatic process that ensures safety and accountability of the user and/or the custodians so that the user and the custodians are notified promptly upon violation of a rule defined in the automatic check-in process.

At operation 508, the user and the custodians receive a check-in notification based on check-in trigger set by the user. The check-in trigger sends a check-in notification to the user and the custodians. At operation 510, the server checks if the user and the custodians have responded to the check-in notification by checking in. If the user and all of the custodians have checked-in in response to the check-in notification, operation 512 is performed, else operation at block 514 is performed.

At operation 512, when check-in of the user/custodians is processed, a data log is updated with a time stamp corresponding to time the user/custodians checked in.

At operation 514, the server 124 checks if the maximum reminder limit on the plurality of frequency to the user and/or the custodians who did not respond to the check-in notification is reached. For instance, if the user does not check-in within 48 hours of receiving the check-in notification, reminders are sent until the maximum limit on reminder frequency are exhausted. If the maximum limit on the reminder frequency is exhausted, then it is treated as a violation by the user and/or the custodians who failed to respond to the check-in notification set by the user. If the maximum limit on the reminder frequency is exhausted, operation 516 is performed else operation 506 is performed.

At operation 516, the server 124 checks if the violation is by the user and/or the custodians. If the violation is by the custodians, then operation 518 is performed else operation 530 is performed. At operation 518, the user is informed about the violation of the custodians. It must be noted that more than one custodian may fail to respond to the check-in notification and all custodians who fail to respond to the check-in notification are termed as violator(s). The server provides details of the custodians (violators) who failed to respond to the check-in notification and reminders. At operation 520, the user can follow-up with the violator(s) offline.

At operation 522, the user 102 determines if he/she wants to keep the custodian who violated. If the user intends to retain the custodian, then operation 524 is performed else operation 526 is performed. At operation 524, the user can re-instate the custodian status of the custodian (violator) if the violators access was suspended or terminated and reset maximum reminder limit (also referred to as ‘a custodian alert counter’). The custodian alert counter on reaching maximum limit of reminders may be reset by the user or the system (Application). At operation 526, if the user does not intend to keep the custodian, the user can release the custodian (violator) from his/her responsibility. At operation 528, if the user chooses to release the custodian (violator) who failed to respond to the check-in notification, a notification is sent to the custodian indicating that he/she has been released from his/her responsibility as custodian of the digital locker associated with the user. The user can chose to release any custodian at any point.

At operation 530, if the server 124 determines that the violator is the user; all the custodians are notified about violation of the user of not responding to the check-in notification. At operation 532, the custodians follow-up with the user (or the user's family/friends) offline to make sure everything is all right. At operation 534, it is determined if the user is alive and healthy to carry out his normal duties. If the user is alive and healthy, operation 536 is performed else operation 538 is performed.

At block 536, the user can go back and reset user alert counter that had reached maximum reminder limit of reminders to get back into the check-in process. The method 500 continues with block 506.

At operation 538, if the user is incapacitated or no longer alive, any custodian can initiate the digital locker disbursement process. For example, if a ‘weekly check-in trigger’, the user and the custodians have to respond to a check-in notification that is sent weekly. The user or the system (Application) may also set a limit on the number of violations. The violation refers to either the user or the custodian not responding to the weekly check-in trigger. In this example, the user sets maximum limit on the number of violations to 3 violations. In an example event, if the user does not respond to the notifications 3 times, all the custodians are informed about the user's violation. Then the custodians can take proper action if this is just a false alarm or a real problem. If the user is incapacitated, the custodians can raise a claim and request for access to the files they were nominated for. The disbursement team responsible for validating the claims and request for access will get involved to verify the claims and grant access to the digital locker upon successful verification.

At operation 540, if the user is no longer alive or unable to respond to the check-in process, all custodians are notified about the user's inability and initiation of the digital locker disbursement process. At operation 542, the digital locker disbursement process is performed. The digital locker disbursement process is further explained in detail with reference to FIG. 6B.

FIG. 6A is a flow diagram of an example method 600 of beneficiary allocation, in accordance with an example embodiment. In an example embodiment, the user (e.g., the testator) can identify up to a predetermined number (e.g., five) of beneficiaries from his custodian list. The testator can assign beneficiaries in the system.

At 602, the user, for example the testator, initiates the beneficiary allocation process. At 604, the user pre-checks if there are assigned caretakers (custodians) for the user. If caretakers are present, the user assigns up to a predetermined number of caretakers such as 5 caretakers as designated beneficiaries, as shown in step 606. If a designated beneficiary is an existing user of the platform, such user is presented with an example notification that “Congratulations, Mr. XYZ designated you his/her beneficiary” at 608. However, if the designated beneficiary is not an existing user of the platform, such user is presented with an example notification that “Mr. XYZ has designated you his/her beneficiary”, and the user is again presented with an option to sign up for the platform, at 608.

If it is determined at 604 that caretakers are not present, the system generates a message that “no caretakers are identified, would you like to add caretakers (assignees)”, as shown in block 610. If user selects to add caretakers, the system launches a process of adding new caretaker (or assignee) at step 612. However, if the user decides not to add caretakers, the method 600 terminates at 614.

FIG. 6B is a flow diagram of an example method 650 for digital locker disbursement process, in accordance with an example embodiment. The sequence of operations of the method 650 may not be necessarily executed in the same order as they are presented. Further, one or more operations may be grouped together and performed in form of a single step, or one operation may have several sub-steps that may be performed in parallel or in sequential manner.

At operation 652, at least one custodian/designated beneficiary (e.g., custodian 114) makes a request for the digital locker disbursement on determining that the user 102 is incapacitated or no longer alive. For instance, the custodian 114 determines that the user 102 is incapacitated when the user 102 fails to respond to the check-in process. Accordingly, the custodian 114 may place a disbursement request for accessing the digital locker of the user 102. The disbursement request includes at least health condition information of the user 102.

At operation 654, the method 650 includes performing a validation of the request for the digital locker disbursement. As the system receives the request for disbursement, the system sends an email to the user (testator) regarding the request for the digital locker disbursement from one of the beneficiary. Also, the admin of the platform/digital locker receives an email of the request for the digital locker disbursement. Alternatively or additionally, such request can also be made in an offline manner such as via sending SMS, making calls or email to the admin.

At 656, the method 650 includes requesting the assignee who made the disbursement request for example, assignee A to submit the relevant documents. The relevant documents may include, but not limited to identity documents of the assignee A, legal documents and medical certificates to confirm that the user is incapacitated. The legal documents and medical certificates can be obtained from corresponding authorities.

At 658, it is checked if the validation is successful or not. As shown in block 660, validation is unsuccessful if one of the following conditions are met. These condition include but not limited to, 1. request for the digital locker disbursement is withdrawn by the assignee A, 2. Admin confirms that disbursement criteria is not met due to unavailability of relevant documents and/or the assignee A having failed to meet the disbursement criteria (if any), and 3. the user (testator) responds suggesting the user is alive. As the validation is unsuccessful, the request for digital locker disbursement is denied at step 662.

Further, as shown in block 664, validation is successful if one of the following conditions are met. These condition include but not limited to, 1) the assignee A provides the relevant documents, 2) Admin gets email conformation from the assignee A and/or verbal validation is successful, and 3) no response received from the user (testator) in a predefined time period say 7 days suggesting the user is not alive.

As the request for digital locker disbursement is validated, verification of the request is initiated at step 666. The step 666 includes operations 668, 670, 672, 674 and 676.

At 668, the disbursement team freezes the digital locker, and at 670, all of the custodians (e.g., assignees B, C and D in addition to the assignee A who initiated) are informed of a verification process of the disbursement via email or any other medium.

At 672, the disbursement team notifies to the assignees to check if there is any objection to the disbursement of the digital locker. If no objection is received within a set time, disbursement process at 678. However, if an objection is received, the admin (or an authorized person from disbursement team) validates the objection at 674. If the objection is determined as genuine at step 676, the request for the digital locker disbursement is denied at step 662.

If the objection is not determined as genuine at step 676, the disbursement process is initiated at step 678. In a non-limiting example embodiment, the step 678 of disbursement process includes steps 680, 682, 684 and 686.

At step 680, all of the assignees (assignees A, B, C and D) are notified to submit the relevant documents for the disbursement process. Some examples of the relevant documents include legal documents such as no objection certificate, identity proof, address proof, medical certificates, and documents associated with valid claims for the disbursement of the digital locker, etc. All of the assignees upload these documents at the platform.

At operation 682, the disbursement team (also referred to as ‘DT’) verifies authenticity and details of the legal documents, medical documents, supporting documents and proofs provided by the assignees A, B, C and D. For instance, the disbursement team checks if the legal documents, medical documents, supporting documents and proofs are acceptable. If the documents (the legal documents, medical documents, supporting documents and proofs) are acceptable, legal clearance is provided at operation 684, otherwise, method 650 proceeds to operation 662.

At operation 686, disbursement process is executed and the account transfer to the payment accounts of the authorized beneficiaries is performed.

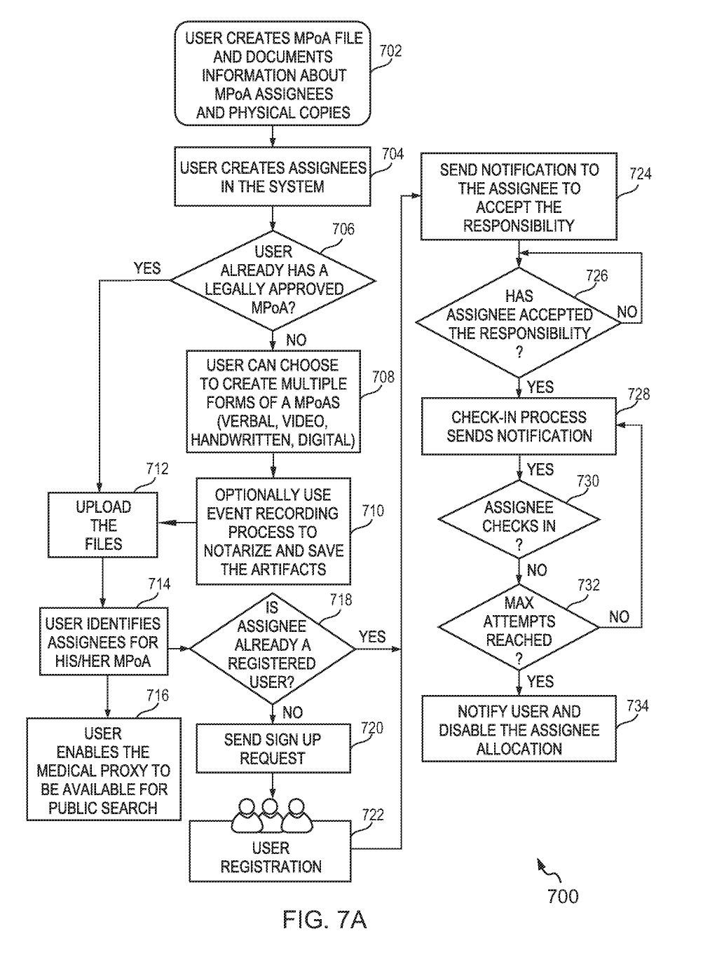

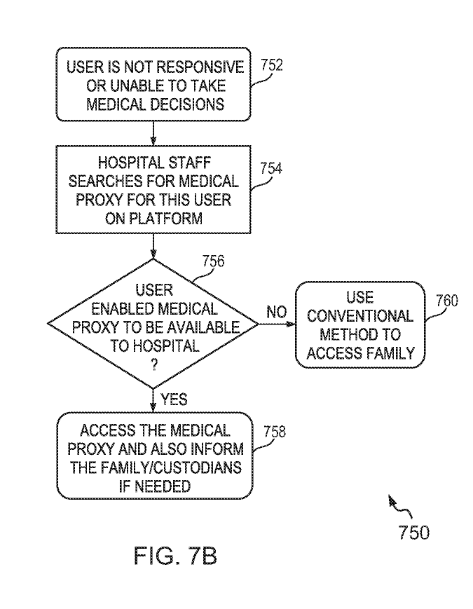

FIG. 7A is a flow diagram of an example method 700 for medical proxy management, in accordance with an example embodiment. The sequence of operations of the method 700 need not to be necessarily executed in the same order as they are presented. Further, one or more operations may be grouped together and performed in form of a single step, or one operation may have several sub-steps that may be performed in parallel or in sequential manner.

At operation 702, the user creates a Medical Power of Attorney (MPoA) record in digital locker. The user provides additional information related to the MPoA, such as, location of the legally approved MPoA(s) (if any), one or more assignee names, contact information associated with the one or more assignees and additional details related to his/her MPoA(s). In an embodiment, the user can also upload any relevant documents, including but not limited to, MPoA files, such as, health condition, healthy history and diagnostic records. At operation 704, the user creates one or more assignees for the MPoA in the digital locker. The one or more assignees refer to people acquainted with the user (e.g., the user 102) who can potentially make health care decisions for the user, as approved by law, when the user is incapacitated and cannot make or communicate decisions. The assignees aid in making healthcare decisions for the user based on legally approved MPoAs created by the user.

At operation 706, the user determines if he/she has a legally approved MPoA. For instance, the user creates an MPoA, and assigns one or more assignees. The MPoA is authorized by a notary (e.g., the notary 106) to ensure legal validation in presence of one or more witnesses. If the user has legally approved MPoA, operation 712 is performed else operation 708 is performed. Even if the user has a legally approved MPoA, he/she can perform operations 708 to add additional layers of protection, such as, visibility to searches, in the digital locker.

At operation 708, user creates one or more forms of MPoA documents in the digital locker. In an embodiment, the MPoA can be created by the user in multiple forms, such as verbal, video, handwritten, digital. It must be noted that the MPoA has no stringent format and can be created by the user in multiple forms to authorize one or more assignees to make health care decisions for the user based on MPoA, as approved by law, when the user is incapacitated. However, the user can provide limitation, specifications and requirements for the assignee to make healthcare decisions.

At operation 710, optionally a live-sign event (also referred to as ‘an authorization event’) is recorded to notarize and save the MPoA documents. The notary creates the live-sign event for the user (i.e. the testator) to authorize one or more assignees and sign the MPoA documents in virtual or physical view of one or more witnesses. The notary creates the authorization event and shares authorization event details including authorization session information and access credentials with the user and the one or more witnesses. In an embodiment, the notary initiates recording of the authorization event upon displaying the MPoA document for the user and the witnesses and requests the user and the witnesses to electronically or physically sign the MPoA documents. The notary verifies the signatures and signs the MPoA document and terminates recording of the live-sign event. The live-sign event recorded by the notary is stored in the digital locker of the user. The sequence of steps for event recording when a testator signs MPoA documents is further explained with reference to FIG. 3. It must be noted that the witnesses or testator can be physically present in same room as the notary and the event recording process does not require all participants to connect remotely with the notary.

At operation 712, the user uploads digital copies of the MPoA files and legal documents corresponding to MPoA in the digital locker. The MPoA files and legal documents comprise information pertaining to the one or more assignees identified by the user and limitations, requirements and specifications for the one or more assignees assigned to make healthcare decisions for the user. At operation 714, user identifies assignees for his/her MPoA. The assignees may or may not have direct vested power to make healthcare decisions for the user when he/she is incapacitated unless they are listed in the legally approved MPoA. The user can choose to provide public access to MPoA comprising assignee contact information, such that, it helps healthcare providers to potentially carry out the user's wishes as per the legally approved MPoA.

At operation 716, optionally the user enables the medical proxy to be available for public search. At operation 718, the server is configured to check if the one or more assignees are registered users. If the assignees are registered users, then operation 724 is performed else operation 720 is performed.

At operation 720, the server sends a sign up request to the assignees that are not registered with the digital locker. At operation 722, the assignees register with the digital locker. In an embodiment, the digital locker requests credentials of the assignees who intend to register with the digital locker.

At operation 724, the server is configured to send a notification to the assignees to accept the responsibility. The notification comprises terms and conditions for the responsibility assigned to the assignee. For instance, when an assignee selected by the user registers with the digital locker, the assignee receives the notification to accept the responsibility of participating in the MPoA process for the user when he/she is incapacitated subject to limitations provided by the user.

At operation 726, the server is configured to check if the one or more assignees have accepted the responsibility. If at least one assignee has not accepted the responsibility, operation 726 is performed till the assignee accepts the responsibility else operation 728 is performed.

In some example embodiments, the operations 724 and 726 are optional operations, and the method 700 directly proceeds to operation 728 from the operations 718 and 722.

At operation 728, the server sends a check-in notification to the one or more assignees for a check-in process. In an embodiment, the user or the system (Application) can set a plurality of reminders for the check-in notification which requires the one or more assignees to respond to the check-in notification by checking-in. The frequency of the plurality of reminders for the check-in process and maximum reminder limit for the one or more assignees who fail to respond to the check-in notification and the plurality of reminders are set by the user. Sending check-in notification for the check-in process of the assignee is further explained with reference to FIGS. 5A-5B.

At operation 730, the server checks if all assignees have checked-in. If at least one assignee has not responded to the check-in notification corresponding to the check-in process, operation 732 is performed else the check-in process is repeated based on frequency set either by the user or default setting by the server.

At operation 732, the server (e.g., the server 124) checks if a maximum reminder limit for the plurality of frequency to the at least one assignee who did not respond to the notification for the check-in process is reached. For instance, if the assignee does not check-in within 12 hours of receiving the check-in notification, reminders are sent until the maximum reminder limit on the plurality of reminders are exhausted. If the maximum reminder limit on the plurality of reminders is exhausted, then it is treated as a violation by the assignee who failed to respond to the check-in notification set by the user. If the maximum reminder limit on the plurality of reminders is exhausted, operation 734 is performed else the operation 728 is performed.

At operation 734, the server notifies the user about the violation of the at least one assignee who failed to respond to the check-in notification. In an embodiment, the server automatically disables the assignee allocation done by the user such that the assignee does not access the MPoA in the digital locker.

FIG. 7B is a flow diagram of an example method 750 for medical proxy management, in accordance with another example embodiment. The sequence of operations of the method 750 need not to be necessarily executed in the same order as they are presented. Further, one or more operations may be grouped together and performed in form of a single step, or one operation may have several sub-steps that may be performed in parallel or in sequential manner.

At operation 752, server determines that a user (testator) is not responsive or unable to take medical decisions. For instance, when the user does not respond to a check-in notification based on check-in trigger set by the user for the check-in process, a claim is raised by a custodian. The custodians follow up with the user and/or family of user offline to ensure if the user is incapacitated to perform his/her normal work.

At operation 754, healthcare providers search for MPoA recorded by the user in the digital locker. For instance, the user may assign one or more assignees in the legally approved MPoA who can make healthcare decisions for the user when he/she is incapacitated to make decisions. The MPoA comprises name of the assignees and the specification, scope for healthcare decision assigned to the assignees. This MPoA is accessed by the healthcare providers such that they can ensure timely healthcare to the user when he/she is incapacitated.

At operation 756, it is determined if the healthcare providers can access the MPoA recorded by the user. If the healthcare providers can access the MPoA of the user, then operation 758 is performed else operation 760 is performed.

At operation 758, the medical proxy of the user is accessed by the healthcare providers for informing at least one of family of the user, assignees or custodians (e.g., the custodians 114, 118). The medical proxy retrieved from the digital locker comprises information about family members, assignees, custodians and emergency contacts. The healthcare providers can access the medical proxy to inform family of the user, the assignees or the custodians about health condition of the user.

At operation 760, when the medical proxy cannot be retrieved by the healthcare providers, and if the user identified any assignees in the digital locker, the healthcare providers can contact the assignees or use conventional methods to access family of the user. For example, a person who accompanied the user during emergency or contact information retrieved from personal belongings is used to inform acquaintances of the user.

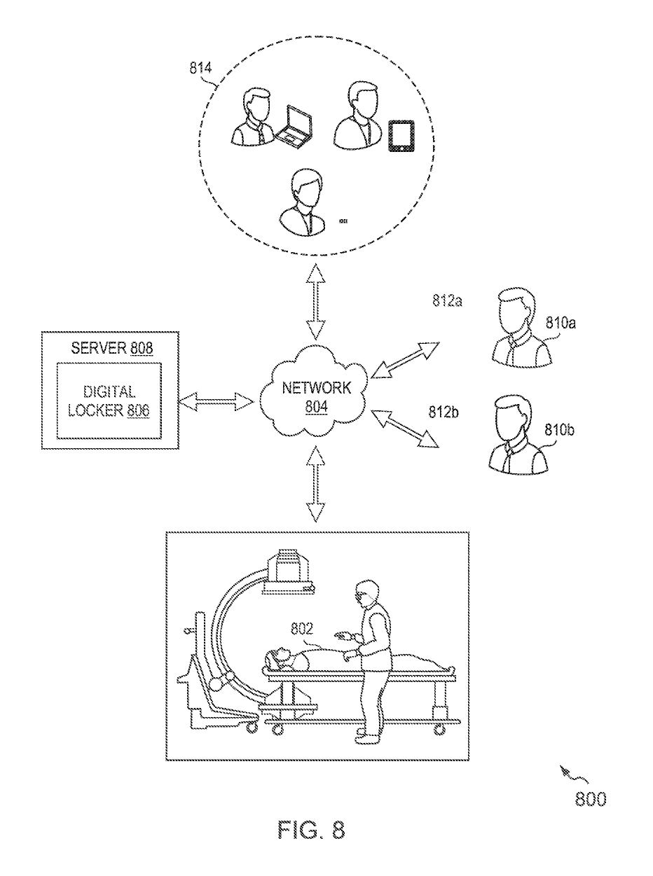

FIG. 8 is a simplified representation 800 for facilitating disbursement of digital locker 806 in one example scenario, in accordance with an example embodiment of the present disclosure. The representation 800 includes an example scenario, where a user 802 associated with the digital locker 806 is unable to respond to the check-in notifications sent by a check in trigger set by the user 802 as the user 802 is in ICU and is battling for life. The user 802 may have assigned two custodians (a custodian 810a and a custodian 810b) for accessing the documents stored in the digital locker 806 in case the user 802 is incapacitated or no longer alive.

As seen in the FIG. 8, entities such as a server 808, the user 802, the custodians 810a and 810b, and a disbursement team 814 are connected to each other via a network 804. The digital locker 806 is hosted and managed by the server 808. In an embodiment, the server 808, upon determining that the user 802 is not responding to the check-in notifications, sends notifications to the custodians 810a and 810b about user's non-responsiveness. The custodians 810a and 810b, upon receiving notification on their mobile devices 812a and 812b respectively, try to follow up with the user 802 and/or family/friends of the user 802. The custodians 810a and 810b may then be alerted of the deteriorating health condition of the user 802 at the ICU. The custodian 810a/810b may send a request to the server 808 for accessing documents stored in the digital locker 806. The server 808 then contacts the disbursement team 814 responsible for disbursing the digital locker 806 associated with the user 802.

The disbursement team 814 may send requirements for disbursing the digital locker 806 to the custodians 810a and 810b. The requirements include legal documents and medical certificates to confirm that the user 802 is no longer alive. The custodians 810a and 810b submits the required documents and certificates to the disbursement team 814. The disbursement team 814 verifies the authenticity of the documents and certificates submitted by the custodians 810a and 810b. After successful verification of the documents, the disbursement team 814 initiates the digital locker disbursement process. The custodians 810a and 810b may be requested to log into a live sign application on their mobile devices 812a and 812b to join a digital locker disbursement event. The disbursement team 814 may hand over the digital locker to the custodians 810a and 810b during the digital locker disbursement event and may keep a recording of the digital locker disbursement event as an artefact for future reference.

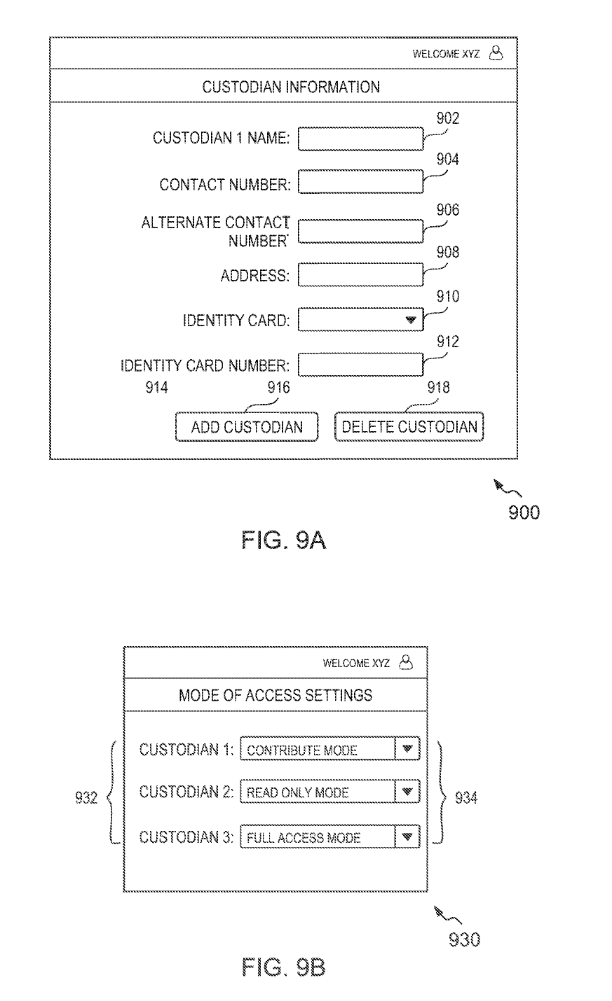

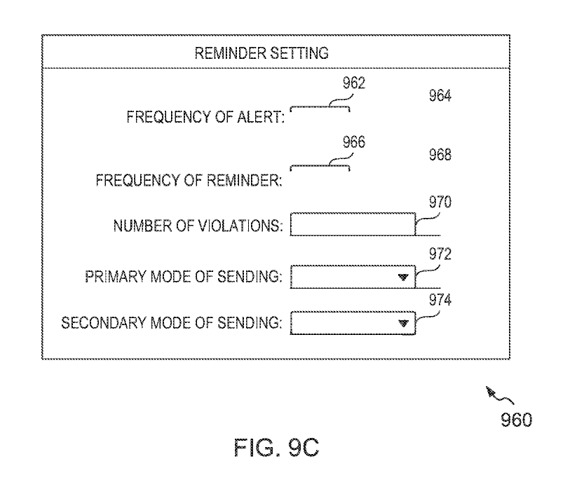

FIG. 9A is a user interface 900 for managing custodians, in accordance with an example embodiment. In this illustrated example representation, the user interface 900 includes a name field 902, a contact number field 904, an alternate contact number field 906, an address field 908, an identity card field 910 and identity card number field 912. A testator (e.g., the testator 102) can add name of the custodian in the name field 902, primary contact number of the custodian in the contact number field 904, secondary contact number of the custodian in the alternate contact number field 904 and address in the address field 908. The identity card field 910 can be a text box or a drop-down menu. The testator can either write the name of the identity card or can choose from the list of the identity card displayed in the drop-down menu. The identity card number field 912 is a text box and the testator may provide the number of an identity card mentioned in the identity card field 910 in the identity card number field 912.

The user interface 900 also includes a save tab 914, an add custodian tab 916 and a delete custodian tab 918. Clicking on the save tab 914 may save the custodian information provided by the testator in a database (e.g., the database 126 of FIG. 1). Clicking on the add custodian tab 916 may provide an option of adding one or more custodians and all the fields (902-912) may also be displayed to the testator for collecting information of the other custodian. Clicking on the delete custodian tab 918 may provide an option of deleting the custodian previously added by the user. For example, the testator wants to delete the custodian whose name is mentioned in the name field 902. So, on clicking the delete custodian tab 918, a check box (not shown) may be displayed near to the name fields of all the custodians added by the testator. The testator may check the check box provided near the name field 902 for deleting the custodian and information related with the custodian.

FIG. 9B is a user interface 930 for setting access control for custodians accessing the digital locker of the user, in accordance with an example embodiment. In the illustrated non-limiting example representation, the user interface 930 comprises a left section 932 and a right section 934. The left section 932 includes name of custodians added by a testator and the right section 934 includes an access mode field for each custodian. The access mode field is a drop down menu and the testator can select any mode from listed access modes in the drop down menu. For example, as seen in FIG. 9B, the testator has selected a contribute mode for the Custodian 1, a read-only mode for Custodian 2 and a full access mode for Custodian 3. Alternatively or additionally, a UI may be presented that allows controlling a type of access at each access level. For instance, the read only access model may be provided to custodians 2 and 3, whereas full access mode may be provided to the custodian 1.

FIG. 9C illustrates a user interface 960 displayed to the user for managing check-in notifications of the user and the custodians, in accordance with an example embodiment. The user interface 960 includes frequency of alert fields associated with textboxes 962 and 964, frequency of reminder fields associated with text boxes 966 and 968, a maximum number of violation field 970, a primary mode of sending field 972 and a secondary mode of sending field 974. The user/testator can provide number of times he/she wants the check-in notifications to be sent to him and the custodians in the text box 962. The textbox 964 is a drop down menu and the testator can select a duration, such as per week, per month, per year from the list in which he/she wants the check-in notifications to be sent to him and the custodians. For example, the testator has provided a value ‘3’ in the textbox 962 and selected ‘per month’ in the textbox 964. So, the testator and the custodians will receive 3 check-in notifications per month.

The testator can define the number of reminders to be sent for check-in notifications in the text box 966. The textbox 968 is a drop down menu and the testator can select a period in which reminders need to be sent, such as after 2 hours, 4 hours, 8 hours etc. The testator can add the number of acceptable violations in the number of violation field 970. The primary mode of sending field 972 is drop down menu and the testator can choose a primary mode of sending notifications from the list of modes displayed in the drop-down menu. The list of modes may contain an email mode, a text mode or a call mode. The secondary mode of sending field 974 is similar to the primary mode of sending field 972. The testator has to select one alternate mode for sending notifications from the list of modes displayed in a drop-down menu of the secondary mode of sending field 974. For example, if the testator has selected primary mode as text then he/she has to select any other mode for sending notifications, such as email, call except text mode.

FIG. 10A is a user interface 1000 depicting live-sign in application, in accordance with an example embodiment. The user interface 1000 displays event recording of a testator (e.g. the testator/user 102) electronically signing authorization documents in virtual view of a notary (e.g. the notary 106) and witnesses (e.g. the witnesses 114 and 118) via the live-sign application. The user interface 1000 displays participants and participant information of a live-sign event in blocks 1002, 1014, 1026, 1038. The block 1002 displays name and designation of the participant 1004 (“James, Notary”) and an image 1006 corresponding to the participant appears beside the name of the participant 1004. The block 1002 displays a symbol 1008 at top left corner of the block 1002 indicating that the participant (the notary) has logged into the live-sign application. The block 1002 also displays an icon 1010 indicating device (smart phone) the participant has used to log into the live sign application. The block 1002 also includes information pertaining to geographical location 1012 of the participant (the notary). The geographical location 1012 of the notary is displayed in terms of geographical co-ordinates, location name and time zone.

The block 1014 displays name and designation of the participant 1016 (“Jane, Witness 1”). The image 1018 of the participant 1016 (witness 1) appears beside the name and designation of the participant 1016. The block 1014 displays a symbol 1020 at top left corner of the block 1014 indicating that the participant 1016 (the witness 1) has logged into the live-sign application. The block 1014 also displays an icon 1022 indicating device (smart phone) the participant 1016 has used to log into the live-sign application. The block 1014 also includes information pertaining to geographical location 1024 of the participant 1016 (the witness 1). The geographical location 1024 of the witness 1 (Jane) is displayed in terms of geographical co-ordinates, location name and time zone.

The block 1026 displays name and designation of the participant 1028 (“Evans, Witness 2”). The image 1030 of the participant 1028 (witness 2) appears beside the name and designation of the participant 1028. The block 1026 displays a symbol 1032 at top left corner of the block 1026 indicating that the participant 1028 (the witness 2) has logged into the live-sign application. The block 1026 also displays an icon 1034 indicating device (computer) the participant 1028 has used to log into the live sign application. The block 1026 also includes information pertaining to geographical location 1036 of the participant 1028 (the witness 2). The geographical location 1036 of the witness 2 (Evans) is displayed in terms of geographical co-ordinates, location name and time zone (Location: 37.4419° N 122. 1430° W, Palo Alto Calif. USA, 11: 10: 12 PST).

The block 1038 displays name and designation of the participant 1040 (“Ray, Testator”). An image 1042 of the participant 1040 (testator) appears beside the name and designation of the participant 1040. The block 1038 displays a symbol 1044 at top left corner of the block 1038 indicating that the participant 1040 (the testator) has logged into the live-sign application. The block 1038 also displays an icon 1046 indicating device (computer) the participant 1040 has used to log into the live-sign application. The block 1038 also includes information pertaining to geographical location 1048 of the participant 1040 (the testator). The geographical location 1048 of the testator (Ray) is displayed in terms of geographical co-ordinates, location name and time zone (Location: 30.2672° N 97. 7431° W, Austin Tex. USA, 13: 10: 12 CST).

The user interface 1000 includes a block 1050 that displays a checklist of procedures to be completed for legally completing the live-sign event below the block 1002. The checklist includes procedures such as, logging in of the notary, witness 1, witness 2 and the testator, identity verification of the participants, document verification (authorization documents), testator signature, witness signature and the notary signature. The notary manually checks a box corresponding to a procedure when a procedure in the checklist is completed. In this example representation, boxes corresponding to procedures of logging in of the notary, witness 1, witness 2 and the testator, identity verification of the participants are checked indicating progress of the live-sign event. The user interface, individual components, login or identification methods, sequence of operations need not to be necessarily executed in the same order or as they are presented in this diagram. Further, one or more operations may be grouped together and performed in form of a single step, or one operation may have several sub-steps that may be performed in parallel or in sequential manner.

The user interface 1000 includes a block 1052 below the block 1048 displaying an icon indicating that the live-sign event is being recorded. The block 1054 beside the block 1038 displays a digital copy of the authorization documents provided by the testator 1040 for authorizing custodians for his/her digital locker.

FIG. 10B is a user interface 1060 depicting Medical Power of Attorney (MPoA) for identifying assignees, in accordance with an example embodiment. The user interface 1060 includes a notes section 1062, a link section 1064, a document section 1066 and an assignees section 1068. The testator (e.g., the testator 102) can list out important/specific points in the notes section 1062. As shown in FIG. 10B, the testator has provided details pertaining to location of physical and digital copies of the MPoA and agents for the MPoA. The testator can edit contents of the notes section 1062 by clicking on edit icon 1070 present at top of the notes section 1062.

The link section 1064 has an option 1072 for the testator to decide if the testator intends to provide public access to the MPoA. The user can click on box corresponding to the option 1072 if he/she intends to provide public access to contents of the MPoA. The link section 1064 includes provisions for the testator to provide a first link 1074 and/or a second link 1076. The first link 1074 and/or the second link 1076 indicate an external link that provides public access to the MPoA corresponding to the testator. For instance, a person accessing medical records for preparing health statistics can access the MPoA of the testator by clicking on the external links (the first link 1074 or the second link 1076). The external links may either navigate person trying to access the MPoA to a drive or a webpage comprising the MPoA of the testator. The testator can edit the external links (the first link 1074 or the second link 1076) by clicking on the edit icon present beside the first link 1074 or the second link 1076.

The documents section 1066 includes an add documents tab 1078. The testator can add documents by clicking on the add documents tab 1078. The documents section 1066 displays documents added by the testator as files/folders 1088a, 1080b, 1080c. The documents may correspond to health documents, such as, health condition, health history, medical diagnosis and vitals corresponding to the testator. In an embodiment, the MPoA can be created by the user in multiple forms, such as verbal, video, handwritten, digital and can be uploaded in the documents section 866. The testator can edit and/or delete the folders 1080a, 1080b, 1080c by clicking on the edit/delete icon present beside each of the folders 1080a, 1080b, 1080c.

The assignee section 1068 displays information of assignees in blocks, 1082, 1084, 1086. The testator can choose to add an assignee by clicking on block 1088 and/or block 1090. The block 1082 displays image of an assignee as a small icon 1092 in top left corner of the block 1082 and name of the assignee (JKL) appears below the icon 1092. Information pertaining to the assignee (JKL), such as, request acceptance/request rejection/request pending is listed below the name along with day. As shown in FIG. 10B, the assignee (JKL) had accepted the request to be an assignee for the MPoA of the testator on Sep. 2, 2017. The testator can edit or delete the assignee by clicking on edit icon and/or delete icon on top right corner of the block 1082. The assignee (RPK) shown by icon 1094 had denied request when he received a request from the testator to be an assignee as indicated by the block 1084. The block 1086 displays an assignee (SPK) with an icon 1096 who has still not responded to assignee request sent by the testator. The testator can choose to add one or more assignees by clicking on the blocks 1088, 1090 and providing information corresponding to the assignee in the block 1088, 1090.

It must be noted that the interface 1060 is shown for representation purposes only and the MPoA record may include fewer or more options for the testator to authorize assignees.

FIG. 10C is a schematic representation of a notification 1095 sent to an assignee, in accordance with an example embodiment. The notification 1095 includes a message section 1096 in which the message describing that a testator (For example, the testator 102) has chosen you as an assignee for his MPoA is displayed. The notification 1095 also includes a link section 1097 in which a hyperlink will be provided. By clicking on that hyperlink, the assignee can confirm his/her acceptance.

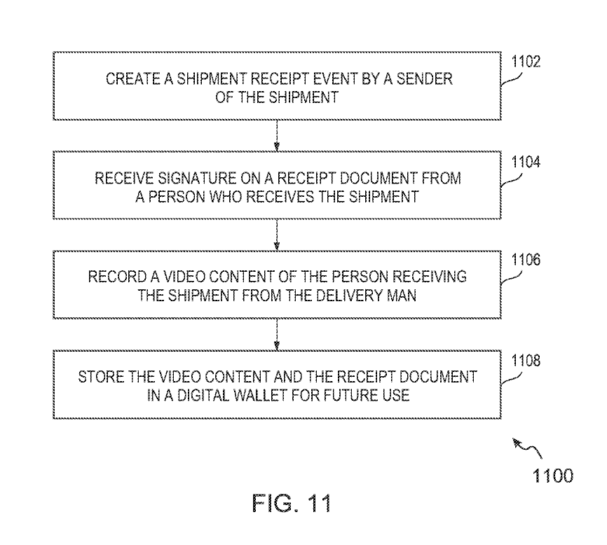

FIG. 11 is a flow diagram of a method 1100 for recording an event when a user receives a shipment is illustrated in accordance with an example embodiment. The method 1100 enablesrecording and storing a video file of a person receiving goods/services. The video file can be retrieved as a proof when a claim is raised by a customer for not receiving goods/services that he/she requested. One or more operations of the method 1100 are carried out at the server 124. The sequence of operations of the method 1100 need not be necessarily executed in the same order as they are presented. Further, one or more operations may be grouped together and performed in form of a single step, or one operation may have several sub-steps that may be performed in parallel or in sequential manner.

At operation 1102, the method 1100 includes creating a shipment receipt event by a sender of the shipment. The shipment includes any kind of goods or services requested or purchased by the customer. The shipment receipt event includes obtaining signature on a receipt document from a person receiving the shipment and recording an event of the person receiving the shipment. The shipment receipt event is created by the sender for every shipment dispatched by the sender via a delivery man of a courier service.

At operation 1104, the method 1100 includes receiving signature from a person who receives the shipment on a receipt document. When the shipment arrives at destination as provided by the customer who purchased (or requested) for the good/services, the delivery man requests the person who receives the shipment to sign the receipt document. It must be noted that the shipment receipt can either be an electronically generated receipt which requires the person receiving the shipment to electronically sign the receipt document or the shipment receipt is a physical document that requires the person collecting the shipment to sign the receipt document manually.

At operation 1106, the method 1100 includes recording a video content of the person/customer receiving the shipment from the delivery man. At block 1108, the method 1100 includes storing the video content and the receipt document in a digital locker for future use. For instance, if the customer who purchased the good/services raises a claim stating that the customer did not receive the shipment comprising the goods, the sender of the shipment can retrieve delivery details of the shipment. The delivery details are the receipt document and the video content that indicates that the person has received the shipment.

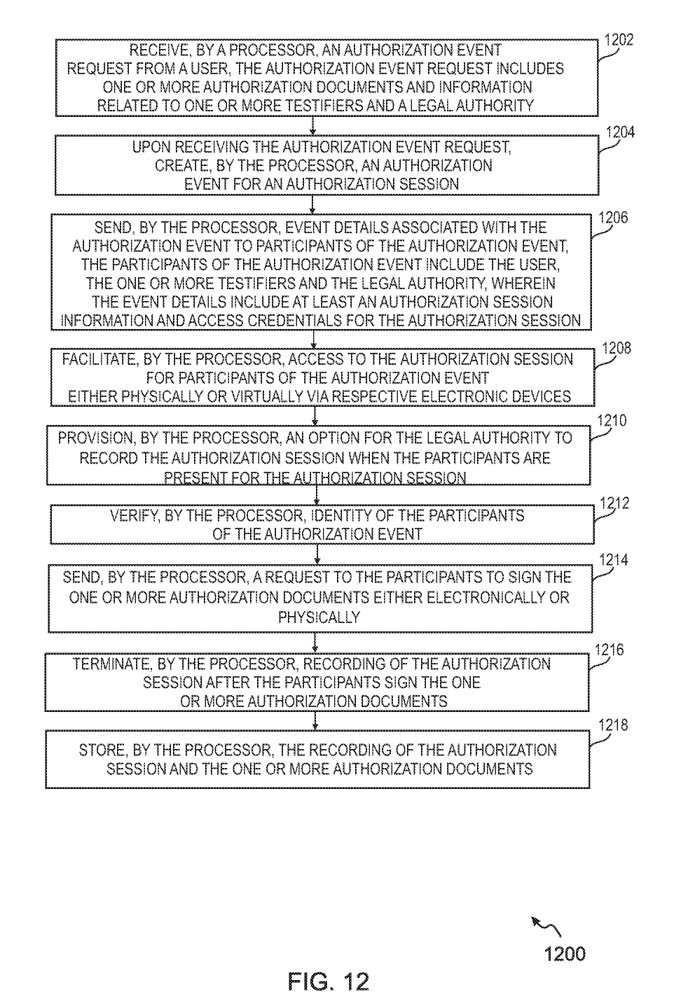

FIG. 12 is a flow diagram of a method 1200 for managing digital assets in accordance with an example embodiment. One or more operations of the method 1200 are carried out at the server 124. The sequence of operations of the method 1200 need not be necessarily executed in the same order as they are presented. Further, one or more operations may be grouped together and performed in form of a single step, or one operation may have several sub-steps that may be performed in parallel or in sequential manner.

At operation 1202, the method 1200 includes receiving, by a processor, an authorization event request from a user. The authorization event request comprising one or more authorization documents and information related to one or more testifiers and a legal authority. The one or more authorization documents relate to a digital locker of the user. The digital locker is configured to store one or more digital contents of the user. The digital content may include any business related proceeding, a will and the like of the user. The user may secure the digital contents in the locker and choose to assign the digital contents as a whole or at least in part to at least one custodian who may access/avail the digital contents based on instructions of the user in the one or more authorization documents. The user places a request to legally perform the entire procedure of assigning the at least one custodian for securing the digital locker in presence of a legal authority, for example, a notary and one or more testifiers (also referred to as ‘one or more witnesses’). Accordingly, the user may access an automated platform (also referred to as ‘a live-sign application’) to place the authorization event request for an authorization session. The user provides the one or more authorization documents that need to be notarized and information related to the participants in the authorization session such as, the user, the notary and the one or more witnesses.

At operation 1204, the method 1200 includes upon receiving the authorization event request, creating, by the processor, an authorization event for an authorization session. The automated platform creates an authorization event for the authorization session. For example, the one or more authorization documents may be prepared in a digital format for facilitating viewing by the participants.

At operation 1206, the method 1200 includes sending, by the processor, authorization event details associated with the authorization event to participants of the authorization event. The participants of the authorization event include the user, the one or more testifiers and the legal authority. The authorization event details comprise at least an authorization session information and access credentials (e.g., user ID, profile ID, password, etc.) for the authorization session. For example, the authorization session information may include a date, a time frame and an agenda for the authorization session. Additionally or optionally, the authorization event details may also include a web link or Uniform Resource Locator (URL) for the participants who intend to participate in the authorization session remotely/virtually. Moreover, the participants who express interest in participating remotely are provided with access credentials such as, login identifier and/or password to join the authorization session.

At operation 1208, the method 1200 includes facilitating, by the processor, access to the authorization session for participants of the authorization event either physically or virtually via respective electronic devices. The participants can access the automated platform for joining the authorization session virtually. In some embodiments, all the participants may be physically present in a same room as the legal authority who may access the automated platform to record the authorization session.

At operation 1210, the method 1200 includes provisioning, by the processor, an option for the legal authority to record the authorization session when the participants are present for the authorization session. The legal authority can record proceedings of the authorization session so as to store a proof of the authorization event.

At operation 1212, the method 1200 includes verifying, by the processor, identity of the participants of the authorization event. The identity of the participants of the authorization session participating virtually and physically are verified by one or more verification techniques such as, identity card issued by an authorized personnel, voice verification, fingerprint verification or retinal scan verification of the participants.

At operation 1214, the method 1200 includes sending, by the processor, a request to the participants to sign the one or more authorization documents either electronically or physically. For example, the one or more authorization documents are displayed to the participants so as to read and verify the authorization documents thoroughly prior to signing the authorization documents. A participant participating in the authorization session virtually signs the one or more authorization documents electronically. A participant participating in the authorization session physically signs the one or more authorization documents physically. The testator signs the authorization document in view of the one or more witnesses and the legal authority, followed by the one or more witnesses of the authorization event and finally the legal authority verifies the one or more authorization document before signing and notarizing the one or more authorization documents related to the digital locker.

At operation 1216, the method 1200 includes terminating, by the processor, recording of the authorization session after the participants sign the one or more authorization documents.

At operation 1218, the method 1200 includes storing, by the processor, the recording of the authorization session and the one or more authorization documents. The authorization documents and the recording of the authorization session are stored in the digital locker so that when the user is incapacitated or no longer alive, the recording and the authorization documents can be used to identify and verify the custodians associated with the digital locker of the user.

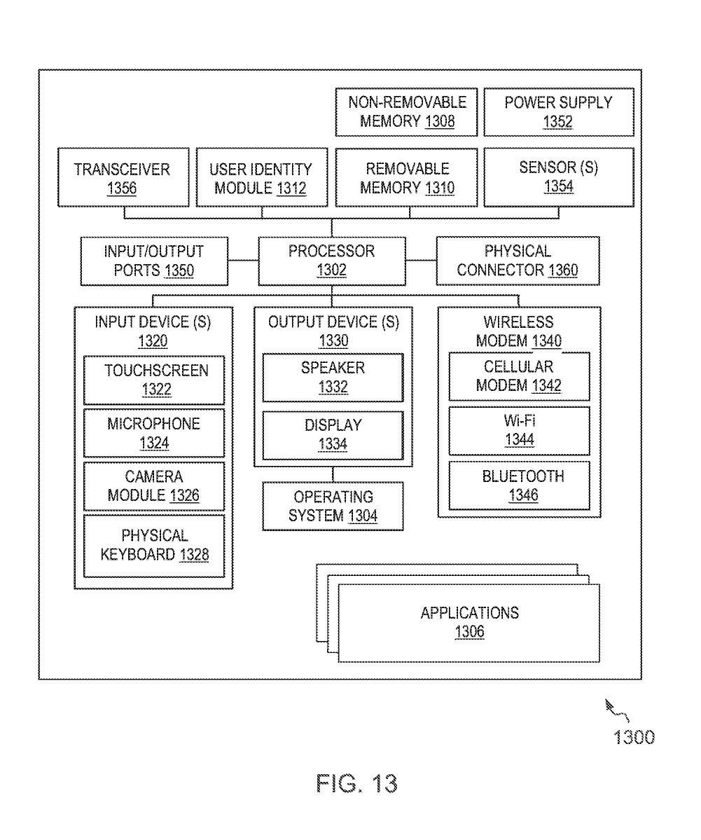

FIG. 13 is a simplified block diagram of an electronic device 1300 capable of implementing the various embodiments of the present disclosure. The electronic device 1300 may be an example of the electronic devices 104, 108 and 112. In an embodiment, the various embodiments related to managing a digital locker of the user can be facilitated using the platform (e.g. the live-sign application) installed in the electronic device 1300. It should be understood that the electronic device 1300 as illustrated and hereinafter described is merely illustrative of one type of device and should not be taken to limit the scope of the embodiments. As such, it should be appreciated that at least some of the components described below in connection with that the electronic device 1300 may be optional and thus in an example embodiment may include more, less or different components than those described in connection with the example embodiment of the FIG. 13. As such, among other examples, the electronic device 1300 could be any of a mobile electronic device or may be embodied in any of the electronic devices, for example, cellular phones, tablet computers, laptops, mobile computers, personal digital assistants (PDAs), mobile televisions, mobile digital assistants, or any combination of the aforementioned, and other types of communication or multimedia devices.

The illustrated electronic device 1300 includes a controller or a processor 1302 (e.g., a signal processor, microprocessor, ASIC, or other control and processing logic circuitry) for performing such tasks as signal coding, data processing, image processing, input/output processing, power control, and/or other functions. An operating system 1304 control the allocation and usage of the components of the electronic device 1300 and support for one or more applications programs (e.g., the live-sign application) that implements one or more of the innovative features described herein. The applications 1306 may include common mobile computing applications (e.g., telephony applications, email applications, calendars, contact managers, web browsers, messaging applications such as USSD messaging or SMS messaging or SIM Tool Kit (STK) application) or any other computing application. The live-sign application is configured to be in operative communication with other applications for example, through the OS or using API Calls, for sending/receiving notifications, such as, check-in notifications.

The illustrated electronic device 1300 includes one or more memory components, for example, a non-removable memory 1308 and/or a removable memory 1310. The non-removable memory 1308 and/or the removable memory 1310 may be collectively known as database in an embodiment. The non-removable memory 1308 can include RAM, ROM, flash memory, a hard disk, or other well-known memory storage technologies. The removable memory 1310 can include flash memory, smart cards, or a Subscriber Identity Module (SIM). The one or more memory components can be used for storing data and/or code for running the operating system 1304 and the touch-typing platform 1306. The electronic device 1300 may further include a user identity module (UIM) 1312. The UIM 1312 may be a memory device having a processor built in. The UIM 1312 may include, for example, a subscriber identity module (SIM), a universal integrated circuit card (UICC), a universal subscriber identity module (USIM), a removable user identity module (R-UIM), or any other smart card. The UIM 1312 typically stores information elements related to a mobile subscriber. The UIM 1312 in form of the SIM card is well known in Global System for Mobile Communications (GSM) communication systems, Code Division Multiple Access (CDMA) systems, or with third-generation (3G) wireless communication protocols such as Universal Mobile Telecommunications System (UMTS), CDMA9000, wideband CDMA (WCDMA) and time division-synchronous CDMA (TD-SCDMA), or with fourth-generation (4G) wireless communication protocols such as LTE (Long-Term Evolution).

The electronic device 1300 can support one or more input devices 1320 and one or more output devices 1330. Examples of the input devices 1320 may include, but are not limited to, a touch screen/a display screen 1322 (e.g., capable of capturing finger tap inputs, finger gesture inputs, multi-finger tap inputs, multi-finger gesture inputs, or keystroke inputs from a virtual keyboard or keypad), a microphone 1324 (e.g., capable of capturing voice input), a camera module 1326 (e.g., capable of capturing still picture images and/or video images) and a physical keyboard 1328. Examples of the output devices 1330 may include but are not limited to a speaker 1332 and a display 1334. Other possible output devices can include piezoelectric or other haptic output devices. Some devices can serve more than one input/output function. For example, the touch screen 1322 and the display 1334 can be combined into a single input/output device.

A wireless modem 1340 can be coupled to one or more antennas (not shown in the FIG. 13) and can support two-way communications between the processor 1302 and external devices, as is well understood in the art. The wireless modem 1340 is shown generically and can include, for example, a cellular modem 1342 for communicating at long range with the mobile communication network, a Wi-Fi compatible modem 1344 for communicating at short range with an external Bluetooth-equipped device or a local wireless data network or router, and/or a Bluetooth-compatible modem 1346. The wireless modem 1340 is typically configured for communication with one or more cellular networks, such as a GSM network for data and voice communications within a single cellular network, between cellular networks, or between the electronic device 1300 and a public switched telephone network (PSTN).

The electronic device 1300 can further include one or more input/output ports 1350, a power supply 1352, one or more sensors 1354 for example, an accelerometer, a gyroscope, a compass, or an infrared proximity sensor for detecting the orientation or motion of the electronic device 1300, a transceiver 1356 (for wirelessly transmitting analog or digital signals) and/or a physical connector 1360, which can be a USB port, IEEE 1294 (FireWire) port, and/or RS-232 port. The illustrated components are not required or all-inclusive, as any of the components shown can be deleted and other components can be added.

The disclosed systems and methods with reference to FIGS. 1 to 12, or one or more operations of the flow diagrams (200-700, 1100 and 1200) may be implemented using software including computer-executable instructions stored on one or more computer-readable media (e.g., non-transitory computer-readable media, such as one or more optical media discs, volatile memory components (e.g., DRAM or SRAM), or non-volatile memory or storage components (e.g., hard drives or solid-state non-volatile memory components, such as Flash memory components) and executed on a computer (e.g., any suitable computer, such as a laptop computer, net book, Web book, tablet computing device, smart phone, or other mobile computing device). Such software may be executed, for example, on a single local computer or in a network environment (e.g., via the Internet, a wide-area network, a local-area network, a remote web-based server, a client-server network (such as a cloud computing network), or other such network) using one or more network computers. Additionally, any of the intermediate or final data created and used during implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

FIG. 14 is a block diagram that illustrates a server 1400, which may be an example of the server 124, in accordance with an embodiment of the present disclosure. The server 1400 includes a computer system 1402 and one or more databases, as a database 1404. The server 1400 also includes an ultra security file storage module 1425. The storage module 1425 consists of a proprietary logic that stored executable instructions to shred (or shard) the encrypted or unencrypted files, and store the shreds on a network of distributed cloud storage systems such as cloud storage systems 1430a, 1430b, 1430c and 1430d connected through a network 1435. Examples of the network 1435 include Cellular network, Wide Area Network (WAN), wireless network, Internet, and any network employing any known communication technologies. A user may have option to store any folder either in a normal mode or in an ultra secure mode. Alternatively or additionally, user may change the status of a content (such as asset, account or folder) from a normal storage mode to the ultra high security storage mode. Once a content is changed into the ultra high security storage mode, the storage module 1425 manages the storage of such content in one or more cloud storage systems using the proprietary logic that includes the executable instructions of shredding or sharding of content or database. In a non-limiting example, the shredded/Sharded content (e.g., by splitting the content in many small parts) along with its metadata may be stored using block chain technology.

The computer system 1402 includes a processor 1406 for executing instructions. Instructions may be stored in, for example, but not limited to, a memory 1408. The processor 1406 may include one or more processing units (e.g., in a multi-core configuration). The processor 1406 is operatively coupled to a communication interface 1410 such that the computer system 1402 is capable of communicating with a remote device such as an electronic device 1420. Some examples of the electronic device 1420 may include, but are not limited to the electronic devices 104, 108 and 112 shown in FIG. 1.

The processor 1406 may also be operatively coupled to the database 1404. The database 1404 is any computer-operated hardware suitable for storing and/or retrieving data. The database 1404 may include multiple storage units such as hard disks and/or solid-state disks in a redundant array of inexpensive disks (RAID) configuration. The database 1404 may include, but not limited to, a storage area network (SAN) and/or a network attached storage (NAS) system.

In some embodiments, the database 1404 is integrated within the computer system 1402. For example, the computer system 1402 may include one or more hard disk drives as the database 1404. In other embodiments, the database 1404 is external to the computer system 1402 and may be accessed by the computer system 1402 using a storage interface 1412. The storage interface 1412 is any component capable of providing the processor 1406 with access to the database 1404. The storage interface 1412 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 1406 with access to the database 1404.

The memory 1408 is a storage device embodied as one or more volatile memory devices, one or more non-volatile memory devices, and/or a combination of one or more volatile memory devices and non-volatile memory devices, for storing micro-contents information and instructions. The memory 1408 may be embodied as magnetic storage devices (such as hard disk drives, floppy disks, magnetic tapes, etc.), optical magnetic storage devices (e.g., magneto-optical disks), CD-ROM (compact disc read only memory), CD-R (compact disc recordable), CD-R/W (compact disc rewritable), DVD (Digital Versatile Disc), BD (Blu-ray® Disc), and semiconductor memories (such as mask ROM, PROM (programmable ROM), EPROM (erasable PROM), flash ROM, RAM (random access memory), etc.).

Although the invention has been described with reference to specific exemplary embodiments, it is noted that various modifications and changes may be made to these embodiments without departing from the broad spirit and scope of the invention. For example, the various operations, blocks, etc., described herein may be enabled and operated using hardware circuitry (for example, complementary metal oxide semiconductor (CMOS) based logic circuitry), firmware, software and/or any combination of hardware, firmware, and/or software (for example, embodied in a machine-readable medium). For example, the apparatuses and methods may be embodied using transistors, logic gates, and electrical circuits (for example, application specific integrated circuit (ASIC) circuitry and/or in Digital Signal Processor (DSP) circuitry).

The present disclosure is described above with reference to block diagrams and flowchart illustrations of method and system embodying the present disclosure. It will be understood that various block of the block diagram and flowchart illustrations, and combinations of blocks in the block diagrams and flowchart illustrations, respectively, may be implemented by a set of computer program instructions. These set of instructions may be loaded onto a general-purpose computer, special purpose computer, or other programmable data processing apparatus to cause a device, such that the set of instructions when executed on the computer or other programmable data processing apparatus create a means for implementing the functions specified in the flowchart block or blocks. Although other means for implementing the functions including various combinations of hardware, firmware and software as described herein may also be employed.

Various embodiments described above may be implemented in software, hardware, application logic or a combination of software, hardware and application logic. The software, application logic and/or hardware may reside on at least one memory, at least one processor, an apparatus or, a non-transitory computer program product. In an example embodiment, the application logic, software or an instruction set is maintained on any one of various conventional computer-readable media. In the context of this document, a “computer-readable medium” may be any non-transitory media or means that can contain, store, communicate, propagate or transport the instructions for use by or in connection with an instruction execution system, apparatus, or device, such as a computer. A computer-readable medium may comprise a computer-readable storage medium that may be any media or means that can contain or store the instructions for use by or in connection with an instruction execution system, apparatus, or device, such as a computer.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, to thereby enable others skilled in the art to best utilize the present disclosure and various embodiments with various modifications as are suited to the particular use contemplated. It is understood that various omissions and substitutions of equivalents are contemplated as circumstance may suggest or render expedient, but such are intended to cover the application and\or implementation without departing from the spirit or scope of the claims.

What is claimed is:

1. A method, comprising:
receiving, by a processor, an authorization event request from a user, the authorization event request comprising one or more authorization documents and information related to one or more testifiers and a legal authority;
upon receiving the authorization event request, creating, by the processor, an authorization event for an authorization session;
sending, by the processor, authorization event details associated with the authorization event to participants of the authorization event, the participants of the authorization event comprising the user, the one or more testifiers and the legal authority, wherein the authorization event details comprise at least an authorization session information and access credentials for the authorization session;
facilitating, by the processor, access to the authorization session for participants of the authorization event via physically or virtually via respective electronic devices;
provisioning, by the processor, an option for the legal authority to record the authorization session when the participants are present for the authorization session;
verifying, by the processor, identity of the participants of the authorization event;
sending, by the processor, a request to the participants to sign the one or more authorization documents either electronically or physically;
terminating, by the processor, recording of the authorization session after the participants sign the one or more authorization documents; and
storing, by the processor, the recording of the authorization session and the one or more authorization documents.

2. The method as claimed in claim 1, wherein the one or more authorization documents are related to a digital locker of the user comprising one or more digital contents, the one or more authorization documents comprise at least one or more of:
medical proxies of the user; and
custodian information related to at least one custodian.

3. The method as claimed in claim 2, further comprising:
facilitating, by the processor, registration of the at least one custodian with the digital locker of the user; and
upon registration of the at least one custodian, facilitating, by the processor, receipt of a user preference input from the user for assigning access control to the at least one custodian, the access control defining a degree of access to the digital locker of the user.

4. The method as claimed in claim 3, wherein the degree of access is at least one of:
a contribute mode for the at least one custodian to add additional digital contents to the digital locker;
a restricted mode, wherein the at least one custodian is denied access to the one or more digital contents in the digital locker;
a read-only mode, wherein the at least one custodian is provided access to view the one or more digital contents of the digital locker;
an edit mode for the at least one custodian to edit the one or more digital contents of the digital locker; and
a full access mode to delete, remove and edit digital contents from the digital locker in the full access mode.

5. The method as claimed in claim 2, further comprising:
generating, by the processor, a check-in notification for the at least one custodian and the user based on a check-in trigger preset by the user; and
receiving, by the processor, a check-in from each of the user and the at least one custodian in response to the check-in notification; and
updating, by the processor, a data log with a time stamp corresponding to a time instant the user and the at least one custodian responded to the check-in notification.

6. The method as claimed in claim 5, further comprising:
determining, by the processor, if the at least one custodian and the user have performed a check-in in response to the check-in notification; and
sending, by the processor, a plurality of electronic reminders to at least one of the user and the at least one custodian who have not responded to the check-in notification, the plurality of reminders being preset by the user.

7. The method as claimed in claim 6, further comprising:
checking, by the processor, if the plurality of electronic reminders exceed a maximum reminder limit resulting in a violation; and
determining, by the processor, if the violation is of the user or the at least one custodian, wherein
upon determining the at least one custodian as performing the violation, provisioning, by the processor, an option for the user to remove the at least one custodian; and
upon determining the user as performing the violation, sending, by the processor, a notification to the at least one custodian.

8. The method as claimed in claim 7, wherein sending the notification comprises:
facilitating, by the processor, an option for the at least one custodian to communicate with the user.

9. The method as claimed in claim 7, wherein upon determining the user as performing the violation, further comprises:
receiving, by the processor, a disbursement request for accessing the digital locker from the at least one custodian, the disbursement request comprising at least health condition information of the user;
processing, by the processor, the disbursement request by creating a disbursement authorization event for a disbursement authorization session; and
sending, by the processor, disbursement event details associated with the disbursement authorization event to the at least one custodian, the disbursement event details comprising at least a disbursement authorization session information and a registration information.

10. The method as claimed in claim 1, wherein sending the authorization event details comprises:
checking, by the processor, if the participants have signed up for the authorization event;
sending, by the processor, a sign-up request to the participants who have not signed up for the authorization event;
sending, by the processor, calendar invitations to the participants who have signed up for the authorization event.

11. The method as claimed in claim 1, wherein verifying the identity of the participants comprise at least one of:
a biometric fingerprint verification;
a voice verification; and
a facial recognition; and
a retinal scan verification.

12. The method as claimed in claim 1, wherein storing the recording of the authorization session and the one or more authorization documents comprises storing in a cloud storage based on a logic stored in a ultra security file storage module, wherein the logic comprises executable instructions for performing at least one of shredding or sharding of the recording and the one or more authorization documents.

13. A server system, comprising:
a memory configured to store instructions; and
a processor configured to execute the instructions stored in the memory and thereby cause the server system to perform:
receiving an authorization event request from a user, the authorization event request comprising one or more authorization documents and information related to one or more testifiers and a legal authority;
upon receiving the authorization event request, creating an authorization event for an authorization session;
sending event details associated with the authorization event to participants of the authorization event, the participants of the authorization event comprising the user, the one or more testifiers and the legal authority, wherein the event details comprise at least an authorization session information and access credentials for the authorization session;
facilitating access to the authorization session for participants of the authorization event either physically or virtually via respective electronic devices;
provisioning an option for the legal authority to record the authorization session when the participants are present for the authorization session;
verifying identity of the participants of the authorization event;
sending a request to the participants to sign the one or more authorization documents either electronically or physically;
terminating recording of the authorization session after the participants sign the one or more authorization documents; and
storing the recording of the authorization session and the one or more authorization documents.

14. The server system as claimed in claim 13, further comprising an ultra security file storage module coupled to the processor, the ultra security file storage module configured to store the recording of the authorization session and the one or more authorization documents in a cloud storage based on a logic stored in the ultra security file storage module, wherein the logic comprises performing at least one of shredding or sharding of the recording and the one or more authorization documents.

15. The server system as claimed in claim 13, wherein the one or more authorization documents are related to a digital locker of the user comprising one or more digital contents, the one or more authorization documents comprise at least one or more of:
medical proxies of the user; and
custodian information related to at least one custodian.

16. The server system as claimed in claim 15, wherein the server system is further configured to perform:
facilitating registration of the at least one custodian with the digital locker of the user; and
upon registration of the at least one custodian, facilitating receipt of a user preference input from the user for assigning access control to the at least one custodian, the access control defining a degree of access to the digital locker of the user.

17. The server system as claimed in claim 15, wherein the server system is further configured to perform:
generating a check-in notification for the at least one custodian and the user based on a check-in trigger preset by the user;
receiving a check-in from each of the user and the at least one custodian in response to the check-in notification; and
updating a data log with a time stamp corresponding to a time instant the user and the at least one custodian responded to the check-in notification.

18. The server system as claimed in claim 17, wherein the server system is further configured to perform:
determining if the at least one custodian and the user have performed a check-in in response to the check-in notification; and
sending a plurality of electronic reminders to at least one of the user and the at least one custodian who have not responded to the check-in notification, the plurality of electronic reminders being preset by the user.

19. The server system as claimed in claim 18, wherein the server system is further configured to perform:
checking if the plurality of electronic reminders exceed a maximum reminder limit resulting in a violation; and
determining if the violation is of the user or the at least one custodian, wherein
upon determining the at least one custodian as performing the violation, provisioning an option for the user to remove the at least one custodian; and
upon determining the user as performing the violation, sending a notification to the at least one custodian.

20. The server system as claimed in claim 19, wherein upon determining the user as performing the violation the server system is configured to perform:
receiving a disbursement request for accessing the digital locker from the at least one custodian, the disbursement request comprising at least health condition information of the user;
processing the disbursement request by creating a disbursement authorization event for a disbursement authorization session; and
sending disbursement event details associated with the disbursement authorization event to the at least one custodian, the disbursement event details comprising at least an disbursement authorization session information and a registration information.

21. A method, comprising:
receiving, by a processor, an authorization event request from a user, the authorization event request comprising information related to one or more participants and one or more authorization documents related to a digital locker of the user, wherein the digital locker comprises one or more digital contents;
upon receiving the authorization event request, creating, by the processor, an authorization event for an authorization session;
sending, by the processor, authorization event details associated with the authorization event to the one or more participants of the authorization event, the authorization event details comprising at least an authorization session information and access credentials for the authorization session;
facilitating, by the processor, access to the authorization session for the participants of the authorization event either physically or virtually;
recording, by the processor, the authorization session when the participants are present for the authorization session;
sending, by the processor, a request to the participants to sign the one or more authorization documents either electronically or physically;
terminating, by the processor, recording of the authorization session after the participants sign the one or more authorization documents;
storing, by the processor, the recording of the authorization session and the one or more authorization documents in the digital locker;
accessing, by the processor, the one or more authorization documents to identify at least one custodian for the digital locker of the user;
facilitating, by the processor, registration of the at least one custodian with the digital locker of the user; and
upon registration of the at least one custodian, facilitating, by the processor, receipt of a user preference input from the user for assigning access control to the at least one custodian, the access control defining a degree of access to the digital locker of the user.

22. The method as claimed in claim 21, wherein the degree of access is at least one of:
a contribute mode for the at least one custodian to add additional digital contents to the digital locker;
a restricted mode, wherein the at least one custodian is denied access to the one or more digital contents in the digital locker;
a read-only mode, wherein the at least one custodian is provided access to view the one or more digital contents of the digital locker;
an edit mode for the at least one custodian to edit the one or more digital contents of the digital locker; and
a full access mode to delete, remove and edit digital contents from the digital locker in the full access mode.
